(19) United States
(12) Patent Application Publication
(10) Pub. No.: US 2025/0302690 A1
(43) Pub. Date: Oct. 2, 2025

(54) Far Infrared Rolling Back Healthcare Massage Device and Rolling Back Method Thereof

(71) Applicant: Miao Liang Li, Riverside,, CA (US)

(72) Inventor: Miao Liang Li, Riverside,, CA (US)

(21) Appl. No.: 18/622,933

(22) Filed: Mar. 30, 2024

(51) Int. Cl. A61H 15/00; A61H 39/04

(52) U.S. Cl. CPC A61H 15/0078; A61H 39/04; A61H 2015/0014; A61H 2201/10; A61H 2203/0418; A61H 2205/081

(57) ABSTRACT

A far infrared rolling back healthcare massage device is provided for a user to perform a flexing and extending movement by leg squatting and rising and to back-massage, acupuncture and moxibustion with noninvasive and painless therapy by self-help at the same time, which includes a rolling back apparatus including an upper supporter and a lower supporter spacedly mounted by a support frame, an elongated rolling back massage stem securely and vertically supported between the upper supporter and the lower supporter for the user to perform a flexing and extending movement by leg squatting and rising with the back of the user touching and pushing rearwards against the massaging arrangement, and a far infrared ray generator which is arranged in the rolling back massage stem and configured to generate at least one far infrared ray radiating towards a treatment space around the rolling back massage stem.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a healthcare massage device, and more particularly to a far infrared rolling back healthcare massage device, which is arranged to assist a user to perform flexing and extending exercise through leg-squatting and rising movement while massaging the user's back acupoints and meridians under far infrared treatment at the same time correspondingly so that the user can achieve fitness and healthcare simultaneously with every flexing and extending movement.

### Description of Related Arts

Nowadays, the pursuit of health and longevity of life is an ultimate goal of human longing. In the exploration of health promotion, human congenital physiological characteristics of intervertebral disk easily lead to diseases and aging, that is just beginning to be recognized by the medical profession. For most, it is still a blind spot, especially for the elders.

The human ageing is from the beginning of the spine. The experts and scholars of research on human spine and health have pointed out that the root causes of human aging and diseases are mainly due to spinal disease and aging. The medical professions have recognized that many chronic diseases are caused by spinal lesions. Germany spine expert, Prof. Dr. Juergen Kraemer said “Disk diseases have existed since the dawn of humanity but are only just beginning to be understood.” “Controlled studies have revealed that every older person occasionally experiences low back pain. The lifetime prevalence of this symptom is thus 100%.” (Intervertebral Disk Diseases, Juergen Kraemer, M.D., Copyright of the original English language edition 2009 by Georg Thieme Verlag KG, Stuttgart, Germany)

As the disc closely related to spine in the infant to eight months, the blood supply has started to close in intervertebral disc, and spinal intervertebral disc in young people has become no blood organization. But it is still adapted to upright walking with various activities, particularly weight-bearing activities. Over the human life, spinal disc depends on the osmosis effect of the semipermeable membrane of the cartilage endplate, so that water and nutrients go into the disc. The congenital physiological characteristics are likely to cause early disc degeneration, gradually increase with age, and are irresistible. With the growth of human life expectancy, people are more likely to face the threat of easy invasion of aging body and sine degenerative diseases. Degenerative disturbances of the structure and function of the intervertebral disks have attracted a great deal of attention in recent decades, both because of their wide intrinsic variety and their widespread effects on other organs.

American Chiropractic founder D.D. Plamer has explained that “Disease, because the nervous system is disturbed—the main point is in the spinal hole of the spinal nerves export.” Therefore, how can we prevent easily leading to diseases and aging from human congenital physiological characteristics of the spine? This a big challenge of human beings.

Prof. Dr. Juergen Kraemer has revealed that the relationship between human body motion and disc physiology healthy: “Measurements of intradiscal pressure reveal that any lateral or anteroposterior bending movement of the trunk changes the overall mechanical stress on the intervertebral disc. Bodily movement thus causes fluid to move into and out of the discs, as well as to shift within the discs themselves.”

According to spinal physiological healthy theory of Prof. Dr. Juergen Kraemer, there are two important implications that, first, it must be targeted to practice spinal movement and, second, the spinal movement is the body's won exercise, other artificial and auxiliary tools can't replace it.

Prof. Dr. Juergen Kraemer further pointed out that a new trend in spine care. “The treatment of cervical syndromes, like that of lumbar syndromes, has changed in recent years. The passive treatments that were previously emphasized, such as massage, realignment, and cervical collars, have largely given way to active ones: gentle exercise and continued physical activity.”

According to the meridian theory of traditional Chinese medicine, an important meridian—Governor vessel—runs along the human spine. Cancer Treatment Centers of America (CTCA) explains that effects of acupuncture and states that “It is believed that energy circulates throughout the body along specific pathways called meridians.

In the human back, there are very important three meridians and acupoints of the Governor vessel, Jia-Ji acupoints and Bladder meridian, that are related to most physiological activities of human life activities.

There are seven branches in total of Governor vessel, Jia-Ji acupoints and Bladder meridian. The seven meridian lines of the body's back and a total of 126 acupoints in the human back, as illustrated in FIG. 1A and FIG. 1B, are where energy gathers and plays out as follows.
(i) Along the spine, on the center of the back referred to as the Governor vessel line and has 14 acupoints.
(ii) Along the left line and right line of Jia-Ji acupoints, referred to as Jia-Ji line, wherein each line has 17 acupoints. That is two lines have 34 acupoints in total.
(iii) Along the left two lines and right two lines of Bladder meridian, wherein each side of the lines has 39 acupoints, i.e. the left and right line have a total of 78 acupoints.

At present, there is no equipment and method for spine care in medical institutions and fitness markets. In addition, body's back and a total of 126 acupoints cannot be touched and massaged by self in daily life healthcare. Mostly, it depends on the professions at the clinic and fails to realize public healthcare through self-help in daily life.

In the healthcare therapy of meridians, in addition to massage, there are also acupuncture and moxibustion, which offer deeper penetration and heat effects. Although acupuncture and moxibustion therapy have a history of several thousand years but they are not popular in public because they need for Doctors of special skills and clinics to perform for the patients, there are invasiveness and pain to the body for acupuncture, and there are inconvenience and potential danger of burns for moxibustion.

Although acupuncture in traditional Chinese medicine plays an irreplaceable role in promoting human health, preventing and treating diseases, due to the high professional and technical requirements, the pain of acupuncture and the potential for burns caused by moxibustion, this valuable human medicine wealth is not popularized to daily healthcare of the public. Wang Xuetai, lifelong honorary chairman of the World Federation of Acupuncture and Moxibustion, proposed: “Improve the clinical level of acupuncture and moxibustion, shift from wide application to focus on overcoming difficult diseases, and make non-acupuncture, non-moxibustion, non-invasive and painless special acupoint therapy as an important self-treatment method for sub-healthy people.” The present invention is to achieve the goal proposed by Wang Xuetai.

Since meridians run between the subcutaneous tendon tissues of the human body, traditional Chinese medicine (TCM) uses acupuncture more penetratingly than massage and the moxibustion uses thermal energy to stimulate the acupoints and meridians. Also, the spinal cord is not only the pathway of nerve conduction but also the center of many reflex activities, wherein the Jia-Ji acupoints are located at the spinous process of the spine and there are spinal nerve roots under the acupoints. Therefore, strengthening the reflex function of the central nervous system substantially activates the neurons through Jia-Ji acupoint. The Jia-Ji acupoints not only regulate the central nervous system but also regulate the peripheral nerves through the central nervous system.

Also, there are twelve pairs Back-Shu acupoints on the first sideline of the Bladder meridian, located close to Governor vessel. Back-Shu acupoints are connected with viscera and organs, which are directly infused by the functions playing of viscera and organs, and the Back-Shu acupoints also directly affect the physiological functions of viscera and organs of the body of the user. Human viscera and organs are controlled by autonomic nerves.

The brain consciousness of the human body cannot control the physiological activities of the viscera and organs. Therefore, by massaging the back acupoints of the bladder meridian for healthcare, the physiological functions of viscera and organs can be actively adjusted and promoted, which puts the human body in a position to dominate its own health. The study by “The National Institute of Neurological Disorders and Stroke” revealed the relationship between human bone marrow and brain cells. “A new study strongly suggests that some cells from bone marrow can enter the human brain and generate new neurons and other types of brain cells.” “This study shows that some kind of cell in bone marrow, most likely a stem cell, has the capacity to enter the brain and form neurons,” says Eva Mezey, M.D., Ph.D., from the National Institute of Neurological Disorders and Stroke (NINDS), who led the study. Proceedings of the National Academy of Sciences, Online Early Edition, Jan. 20, 2003. Last Modified Aug. 7, 2009.

The Governor vessel joins the Bladder meridian and connects the kidneys and enters the brain of the head upwards from the tailbone of the spine. Bladder meridian starts from outside the inner canthus of the eyes of the face and connects to the brain from the top of the head. Then, the Bladder meridian separates left and right and goes down the back of the spine, along the inner side of the scapula, on both sides of the spine, to the waist, goes deep into the body cavity from the paraspinal muscles, connects with the kidneys, and belong to the bladder. The two meridians connect the functions of the kidneys, spinal cord and brain.

Furthermore, the benefits of far infrared rays on the human body have been proven and widely used. Fatma Vatanserver, Michael R Hamblin, discloses the biological effects and medical applications of far infrared radiation (FIR). Far infrared (FIR) radiation ((λ=3-100 μm) is a subdivision of the electromagnetic spectrum that has been investigated for biological effects. The goal of this review is to cover the use of a further sub-division (3-12 μm) of this waveband, that has been observed in both in vitro and in vivo studies, to stimulate cells and tissue, and is considered a promising treatment modality for certain medical conditions.

Technological advances have provided new techniques for delivering FIR radiation to the human body. Specialty lamps and saunas, delivering pure FIR radiation (eliminating completely the near and mid infrared bands), have become safe, effective, and widely used sources to generate therapeutic effects. Fibers impregnated with FIR emitting ceramic nanoparticles and woven into fabrics, are being used as garments and wraps to generate FIR radiation and attain health benefits from its effects.” (https://pubmed.ncbi.nlm.nih.gov/23833705/)

On Sep. 30, 2015, the World Health Organization (WHO) issued a report of “World Aging and Health”: “60 years of age or older population will be double by 2050, today is the first time in history that most people can expect to live to 60 years of age. Thus, the pressure on health, health systems, labor force and the state budget are enormous.”

Accordingly, it would be appreciated for any healthcare daily healthcare treatment that the user may perform by himself or herself to exercise while receiving back massage and acupuncture and moxibustion treatment under far infrared rays with respect to Governor vessel, Jia-Ji acupoints, Bladder meridian and 126 acupoints in his or her back in a noninvasive and painless manner at home. The popularization of the present invention will play an immeasurable role in improving the health level of the public, especially the elderly. Also, it is of great significance to promote the development of national economies around the world.

### SUMMARY OF THE PRESENT INVENTION

The invention is advantageous in that it provides a rolling back method that allows the user to perform physical exercise equipping with a far infrared rolling back healthcare massage device so as to combine exercise, back massage, and acupuncture and moxibustion with non-invasive and painless therapy.

Another advantage of the invention is to provide a rolling back method that allows the user to perform physical exercise while running along the human spine which is Governor vessel and is performed along Governor vessel, Jia-Ji acupoints and Bladder meridian in sequence.

Another advantage of the invention is to provide a far infrared rolling back massage device which allows the user to perform physical exercise while rolling against the Governor vessel line, Jia-Ji lines and the Bladder meridian lines in the back of the user under appropriate far infrared ray to achieve a fitness plus healthcare treatment.

Another advantage of the invention is to provide a far infrared rolling back massage device which provides a far infrared radiation environment to the user who is doing a rolling back exercise therewith such that the far infrared rays provide penetrating power and thermal energy for treatment of the Governor vessel line, Jia-Ji lines and the Bladder meridian lines in the back of the user to achieve the results of acupuncture and moxibustion of TCM.

Another advantage of the invention is to provide a non-acupuncture, non-moxibustion, non-invasive and painless acupoint therapy by performing a back rolling method while equipping with a far infrared rolling back massage device.

Another advantage of the invention is to provide a far infrared rolling back healthcare massage device which is arranged to be equipped with the user's body flexing and extending exercise such that the leg-squatting and rising movement of the user drives the upper trunk of the user to scroll back on a rolling back apparatus to achieve exercise and healthcare massage of the spine and the back acupoints and meridians of the user while receiving moxibustion therapy with far infrared implementation.

Another advantage of the invention is to provide a far infrared rolling back healthcare massage device which allows the user to experience a combination of exercise, back massage and acupuncture and moxibustion with non-invasive and painless therapy so as to provide a fitness plus healthcare achievement to the user.

Another advantage of the invention is to provide a far infrared rolling back healthcare massage device which is configured to be assembled by the user so that the user can experience TCM acupuncture at home or working place anytime, that helps thousands of households and popularizes to the public to not only help humans challenge themselves but also delay congenital degeneration of the spine.

Another advantage of the invention is to provide a far infrared rolling back healthcare massage device which helps solving the health problems faced by the elderly as human age, such as in old age, sarcopenia causing the deterioration of health conditions and brain atrophy causes Alzheimer's disease.

Another advantage of the invention is to provide a far infrared rolling back healthcare massage device which is arranged to have at least one massaging face of a rolling back apparatus equipped with an enclosed far-infrared ray generator in such a manner that, when a DC or AC power supply is turned on and the user performs back rolling massage and acupuncture and moxibustion therapy, the far infrared ray is able to reach the body's back meridians and acupoints through the massaging face.

Another advantage of the invention is to provide a far infrared rolling back healthcare massage device which provides various massaging faces according to the physiological structure of the spine and Jia-Ji acupoints, as well as the physiological structure of Bladder meridian, which are configured and arranged to be convenient for users to accurately position for the healthcare of the back massage and to realize “non-acupuncture and non-moxibustion and more efficient for non-invasive and painless special acupoint therapy.

Another advantage of the invention is to provide a far infrared rolling back healthcare massage device, wherein the rolling back apparatus thereof contributes a hardware arrangement of exercise, rolling back healthcare massage and far infrared therapy to the back of the user while the far infrared ray generator and the rolling back method of the invention contribute a software arrangement of healthcare massage on Governor vessel, Jia-Ji acupoint and Bladder meridian in sequence encouraging the user to execute realistic and long-term significance in helping himself or herself according to the sequence of meridians and acupoints and to realize the goal of challenging oneself and pursuing health and longevity.

Another advantage of the invention is to provide a far infrared rolling back healthcare massage device, wherein the rolling back apparatus and the far infrared ray generator thereof contribute a hardware arrangement, that is a physical entity of the human body and the device, wherein the user's body exercise with respect to the rolling back apparatus ensures the effects of far infrared rays for meridians and acupoints.

Another advantage of the invention is to provide a rolling back method with a far infrared rolling back healthcare massage device, which is a program that integrates fitness and health care simultaneously, wherein the rolling back apparatus thereof contributes a hardware arrangement that essentially embodies the matter form of the human body, while the far infrared ray generator and the rolling back method of the invention contribute a software arrangement that embodies the energy form of the human body. Therefore, in the implementation of hardware arrangement and the software arrangement of the far infrared rolling back healthcare massage device of the invention, a trinity system of the dynamic balance of the material form and the energy form for fitness and healthcare of human life activities is promoted, thereby achieving the goals of maintaining health, preventing disease and delaying aging.

Another advantage of the invention is to provide a rolling back method with a far infrared rolling back healthcare massage device, which far infrared ray generator is configured to provide the same effect of the penetrating the subcutaneous tissue like the acupuncture of TCM without even touching the skin of the user's body nor burning the skin like the moxibustion of TCM by means of the proper far infrared rays radiated by the far infrared ray generator, so as to achieve two therapies of acupuncture and moxibustion at the same time with the far infrared radiation while experiencing massage along Governor vessel, Jia-Ji acupoints and Bladder meridian in the back of the user by the rolling back apparatus of the invention so as to form a trinity structure of regulating and promoting the function of the physiological system of the body comprehensively.

Another advantage of the invention is to provide a rolling back method with a far infrared rolling back healthcare massage device for achieving the following effects:
regulating and promoting the physiological functions of the central nervous system;
regulating the coordination relationship between the central nervous system and visceral organs, and activating the vitality of kidney, spinal cord and brain cells, and promoting regeneration of the spinal cord and brain cells; and
regulating and promoting the physiological functions of viscera and organs.

Another advantage of the invention is to provide a far infrared rolling back healthcare massage device which is configured to allow the user's spine leaning against and pressing on the rolling back apparatus thereof while performing a rolling back exercise, such that the crowded force of the rolling back apparatus produces the effects of the wright-bearing on spine, that can help to increase the density of spinal bone.

Another advantage of the invention is to provide a far infrared rolling back healthcare massage device which rolling back apparatus allows the user to exercise therewith to perform messages along the Jia-Ji acupoints located on both sides of the spine, so as to adjust the intervertebral disc deviation of the spine and have the function of chiropractic correction.

Another advantage of the invention is to provide a far infrared rolling back healthcare massage device which allows the user to perform flexing and extending movement by leg squatting and rising to realize whole body exercise and promote spinal blood circulation and spinal functions and prevent hunchbacked.

Another advantage of the invention is to provide a far infrared rolling back healthcare massage device which enables the user to focus on promoting spinal health, to treat the brain and spinal cord as the central nervous system as one, to provide nutrients to the cells of the central nervous system, to enhance the metabolism of the waste produced due to cell metabolism, and to maintaining the normal metabolism of cells when the human body maintains normal blood circulation and physiological functions by means of the exercise against the far infrared rolling back healthcare massage device, and thus promotes and restores the physiological functions of the central nervous system.

Another advantage of the invention is to provide a far infrared rolling back healthcare massage device, which allows the user to execute a rolling back massage method of exercise with respect to the 34 Jia-Ji acupoints on both sides of the cervical spine to the sacrum, wherein the Jia-Ji acupoints are closely connected with the central nervous system, so that through the rolling back method, the impulse afferent nerve stimulating ensures the Jia-Ji acupoints reaching the hypothalamus, and the brainstem reticular structure also plays an important role in the pathway for the impulse to reach the hypothalamus.

Another advantage of the invention is to provide a far infrared rolling back healthcare massage device, which allows the user to execute a rolling back massage method of exercise along the Back-Shu acupoints of the Bladder meridian of the user to coordinate and promote the relationship and function between viscera and organs and to realize the unction of actively adjusting and promoting the physiological system of the body of the user, and along the Governor vessel of the user to synergistically promote kidney function, spinal cord and brain connection. Thereby the functions of the central nervous system and internal organs are promoted correspondingly. Since the human viscera and organs are controlled by autonomic nerves and the brain consciousness of the human body cannot control the physiological activities of the viscera and organs. Accordingly, by massaging the back acupoints of the bladder meridian for healthcare by the far infrared rolling back healthcare massage device while doing the rolling back exercise of the invention, the physiological functions of viscera and organs can be actively adjusted and promoted, which puts the human body in a position to dominate its own health.

Another advantage of the invention is to provide a far infrared rolling back healthcare massage device, which allows the user to execute a rolling back massage method of exercise along the Governor vessel, Jia-Ji acupoints and Bladder meridian under the far infrared radiation, that substantially unblocks and activates the connection between kidney function, spinal cord and brain function, activates and promotes the regeneration of nerve cells and brain cells. The trinity structure of the invention reveals the connection between the human Governor vessel and the Bladder meridian and activates the kidney function and cellular function of the spinal cord and brain, that shows the physiological basis for Dr. Eva Mezey's research result.

Another advantage of the invention is to provide a far infrared rolling back healthcare massage device, which allows the user to experience a process of health massage while conducting exercise therewith, through which the upper limbs, lower limbs and trunk of the body of the user, including the muscles and tendons of the neck, have been stretched and contracted, that realizes the effect of mutual promotion of fitness and healthcare, thereby achieving the function of stimulating the body to activate cell vitality.

Another advantage of the invention is to provide a far infrared rolling back healthcare massage device, which is natural, safe, self-help, self-adjusting, convenient, economical, and effective. Thus, it is widely applicable to all adult people.

Additional advantages and features of the invention will become apparent from the description which follows, and may be realized by means of the instrumentalities and combinations particular point out in the appended claims.

According to the present invention, the foregoing and other objects and advantages are attained by a far infrared rolling back healthcare massage device for a user to perform a flexing and extending movement by leg squatting and rising and to back-massage, acupuncture and moxibustion with noninvasive and painless therapy by self-help at the same time, comprising:
a support frame comprising a left handle and a right handle respectively provided at a left side and a right side thereof; and
a rolling back apparatus, supported by the support frame, comprising:
an upper supporter and a lower supporter spacedly mounted by the support frame to have an exercise distance therebetween;
an elongated rolling back massage stem securely and vertically supported between the upper supporter and the lower supporter and having a front side and a rear side;
a massaging arrangement comprising an elongated body provided along at least one portion of the front side of the rolling back massage stem and a plurality of massaging elements protruded on the body and oriented for selectively touching, rubbing and kneading against a back of the user when the user is performing the flexing and extending movement by leg squatting and rising with the back of the user touching and pushing rearwards against the massaging arrangement; and
a far infrared ray generator which is arranged in the rolling back massage stem and extended along the massaging arrangement and configured to generate at least one far infrared ray with a predetermined frequency radiating towards a treatment space around the rolling back massage stem while the user is exercising with the far infrared rolling back massage device.

In one embodiment, the far infrared rolling back massage device further comprises a safety apparatus coupled with the support frame for the user to secure while doing the flexing and extending movement with respect to the massaging arrangement.

In one embodiment, the safety apparatus comprises safety belts arranged at a left upper bracket and a right upper bracket of the support frame within a hand reaching distance from the rolling back massage stem, such that the user can put the loop of the safety belts on the upper arms thereof to prevent the user from falling to the ground during conducting the exercise and healthcare massage.

In one embodiment, the left handle and right handle are configured to allow both hands of the user to hold on respectively while performing the flexing and extending movement and allow the user to push the left handle and right handle to generate a reaction force rearwards to push the back of the user against the massaging arrangement so as to self-apply a massaging pressure on a portion of the back of the user where pushing against the rolling back massage stem for back massaging.

In accordance with another aspect of the invention, the present invention comprises a rolling back method of a far infrared rolling back healthcare massage device, comprising:
(a) providing an elongated rolling back massage stem securely and vertically supported by a support frame on an exercise surface and emitting a far infrared ray from a far infrared ray generator, which is provided along the rolling back massage stem, towards a treatment space of the far infrared rolling back healthcare massage device;
(b) starting from a leg squatting position by a user within the treatment space while a coccyx portion along a Governor vessel line of a back of the user pushing against a facing side of the rolling back massage stem;
(c) gradually rising up from the leg squatting position to a rising position by the user while a lumbar vertebra portion, a thoracic vertebra portion and a seventh cervical vertebra portion of the back of the user pushing against the facing side of the rolling back massage stem in sequence along the Governor vessel line joining the coccyx portion, the lumbar vertebra portion, the thoracic vertebra portion, and the seventh cervical vertebra portion of the back of the user;
(d) gradually squatting down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the Governor vessel line joining the coccyx portion, the lumbar vertebra portion, the thoracic vertebra portion, and the seventh cervical vertebra portion of the back of the user;
(e) repeating the step (c) and the step (d) for a corresponding time periods in sequence.
(f) starting from the leg squatting position by the user while the coccyx portion along each of the two lines of Jia-Ji acupoints of the back of the user pushing against the facing side of the rolling back massage stem;
(g) gradually rising up from the leg squatting position to the rising position by the user while the lumbar vertebra portion, the thoracic vertebra portion and the seventh cervical vertebra portion of the back of the user pushing against the facing side of the rolling back massage stem in sequence along each of the two lines of Jia-Ji acupoints joining the coccyx portion, the lumbar vertebra portion, the thoracic vertebra portion, and the seventh cervical vertebra portion of the back of the user;
(h) gradually squatting down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the each of the two lines of Jia-Ji acupoints joining the coccyx portion, the lumbar vertebra portion, the thoracic vertebra portion, and the seventh cervical vertebra portion of the back of the user;
(i) repeating the step (g) and the step (h) for a corresponding time periods in sequence.
(j) starting from the leg squatting position by the user while the coccyx portion along each of the four bladder meridian lines of Jia-Ji acupoints of the back of the user pushing against the facing side of the rolling back massage stem;
(k) gradually rising up from the leg squatting position to a rising position by the user while the lumbar vertebra portion, the thoracic vertebra portion and the seventh cervical vertebra portion of the back of the user pushing against the facing side of the rolling back massage stem in sequence along each of the four bladder meridian lines joining the coccyx portion, the lumbar vertebra portion, the thoracic vertebra portion, and the seventh cervical vertebra portion of the back of the user;
(l) gradually squatting down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the each of the four bladder meridian lines joining the coccyx portion, the lumbar vertebra portion, the thoracic vertebra portion, and the seventh cervical vertebra portion of the back of the user; and
(m) repeating the step (k) and the step (l) for a corresponding time periods in sequence.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is a schematic diagram illustrating meridian and acupoints of a back of a human user.

FIG. 1B is a schematic view illustrating the Governor vessel line, the two lines of Jia-Ji acupoints and the four Bladder meridian lines of the back of the human user.

FIG. 2 is a perspective view of a far infrared rolling back healthcare massage device according to a preferred embodiment of the present invention.

FIG. 3 is a perspective view of an upper supporter of a rolling back apparatus of the far infrared rolling back healthcare massage device according to the above preferred embodiment of the present invention.

FIG. 4 is perspective view of a lower supporter of the rolling back apparatus of the far infrared rolling back healthcare massage device according to the above preferred embodiment of the present invention.

FIG. 5 is an exploded perspective view of the lower supporter and the rolling back massage stem of the rolling back apparatus of the far infrared rolling back healthcare massage device according to the above preferred embodiment of the present invention.

FIG. 6 is an exploded perspective view of the rolling back apparatus of the far infrared rolling back healthcare massage device according to the above preferred embodiment of the present invention.

FIG. 7A is a schematic view illustrating the first massaging elements on the rolling back massage stem of the rolling back apparatus of the far infrared rolling back healthcare massage device according to the above preferred embodiment of the present invention.

FIG. 7B is a schematic view illustrating a second massaging elements of the massaging elements on the rolling back massage stem of the far infrared rolling back healthcare massage device according to the above preferred embodiment of the present invention.

FIG. 7C is a schematic view illustrating a third massaging elements of the massaging elements of the rolling back apparatus of the far infrared rolling back healthcare massage device according to the above preferred embodiment of the present invention.

FIG. 8 is a schematic view illustrating a sleeve of covering three massage elements of the rolling back apparatus of the far infrared rolling back healthcare massage device according to the above preferred embodiment of the present invention.

FIG. 9A is an enlarged view of the massaging element as shown in FIG. 7A according to the above preferred embodiment of the present invention.

FIG. 9B is an enlarged view of the massaging element as shown in FIG. 7B according to the above preferred embodiment of the present invention.

FIG. 9C is an enlarged view of the massaging element as shown in FIG. 7C according to the above preferred embodiment of the present invention.

FIG. 9D is a partial and sectional view of an alternative mode of the massaging element of the massaging arrangement of the rolling back apparatus of the far infrared rolling back healthcare massage device according to the above preferred embodiment of the present invention.

FIG. 10A is a partial perspective view of a center rod of the rolling back massage stem of the rolling back apparatus of the far infrared rolling back healthcare massage device according to the above preferred embodiment of the present invention.

FIG. 10B is another partial perspective view of far infrared generator is fixed on the center rod in the rolling back massage stem of the rolling back apparatus of the far infrared rolling back healthcare massage device according to the above preferred embodiment of the present invention.

FIG. 10C is a perspective view illustrating an example of a far infrared ray member embodied as the far infrared ray generator for wrapping around the rolling back massage stem of the rolling back apparatus of the far infrared rolling back healthcare massage device according to the above preferred embodiment of the present invention.

FIG. 11 is a perspective view of a first alternative mode of the far infrared rolling back healthcare massage device according to the above preferred embodiment of the present invention.

FIG. 12 is a partial exploded perspective view of the far infrared rolling back healthcare massage device according to the above preferred embodiment of the present invention.

FIG. 13A is an enlarged view of the portion C as shown in FIG. 12 according to the preferred embodiment of the present invention.

FIG. 13B is an enlarged view of the portion D as shown in FIG. 12 according to the preferred embodiment of the present invention.

FIG. 14 is a perspective view of the rolling back massage stem and massaging arrangement 24 mounted thereon of the rolling back apparatus of the far infrared rolling back healthcare massage device according to the above preferred embodiment of the present invention.

FIG. 15 is a schematic view illustrating the pathway of Governor vessel which is consistent with the spinal cord and brain as the central nervous system of the human user according to the above preferred embodiment of the present invention.

FIG. 16 is a schematic view illustrating 34 acupoints of Huatuo Jia-Ji acupoints (17 acupoints on each of the left side and the right side of the Governor vessel) in the back of the human user according to the above preferred embodiment of the present invention.

FIG. 17 is a schematic view illustrating the correspondence between Back-Shu acupoints of the bladder meridian and the internal organs and viscera of the human user according to the above preferred embodiment of the present invention.

FIG. 18 is a schematic side view illustrating the physiological route of energy operation of kidney function, spinal cord and brain of the human user according to the above preferred embodiment of the present invention.

FIG. 19 is a schematic side view illustrating the forces on spine of the human user according to the above preferred embodiment of the present invention.

FIG. 20 is an enlarged schematic view illustrating the relationship of discs and the impinged nerve according to the above preferred embodiment of the present invention.

FIG. 21 is a schematic view illustrating the action of a rolling back method of the far infrared rolling back healthcare massage according to the preferred embodiment of the present invention.

FIG. 22A is a plan view of a foot massage mat of the far infrared rolling back healthcare massage device according to the preferred embodiment of the present invention.

FIG. 22B is an enlarged view illustrating example of acupressure protrusions that can be configured on the foot massage mat according to the preferred embodiment.

FIG. 22C is a schematic view illustrating acupoints of soles of left and right human feet according to the preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “connected,” “attached,” and “fixed” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “above” or “below” the second feature, this may entail direct physical contact between the two features. Alternatively, it may signify that the first and second features are not in direct contact but are linked through the involvement of additional features. Additionally, the description of the first feature being “above,” “over,” or “on top of” the second feature includes scenarios where the first feature is positioned directly above or diagonally above the second feature or simply means that the first feature is situated at a higher horizontal level than the second feature. Conversely, when the first feature is referred to as “below,” “under,” or “beneath” the second feature, it encompasses cases where the first feature is directly below or diagonally below the second feature or simply implies that the first feature's horizontal height is less than that of the second feature.

In this embodiment's description, terms such as “up,” “down,” “right,” and “left” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

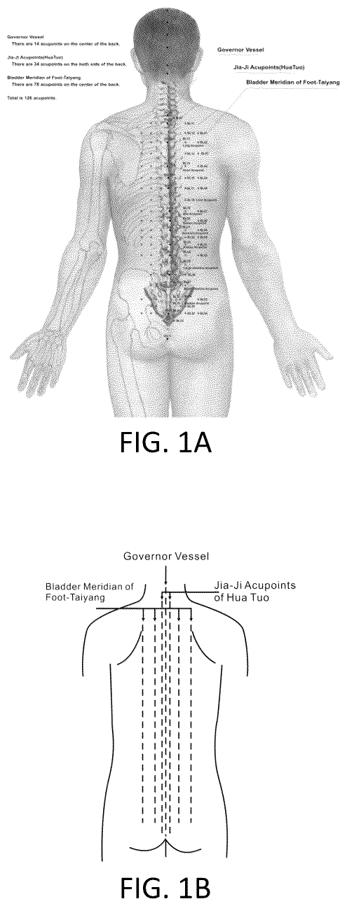

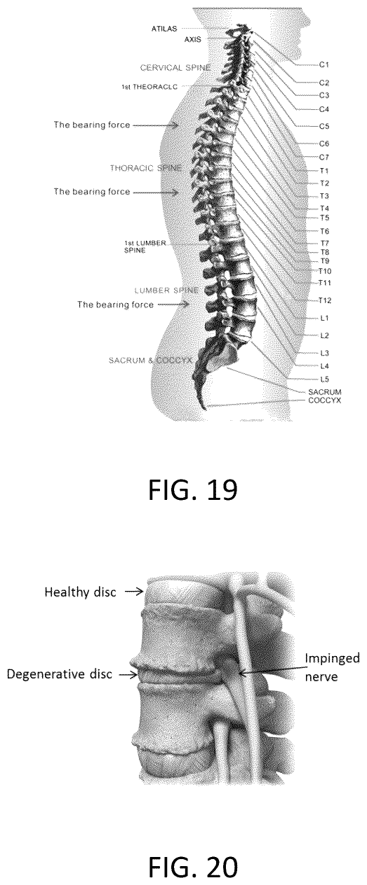

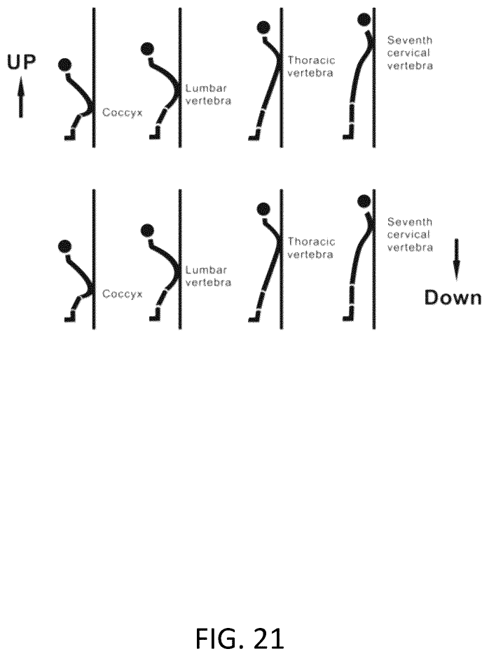

Referring to FIG. 1A-FIG. 1B and FIG. 15-FIG. 20, a central Governor vessel line, two lines of Jia-Ji acupoints adjacent to two sides of the Governor vessel line and two pairs of bladder meridian lines adjacent to the two lines of Jia-Ji acupoints respectively are illustrated.

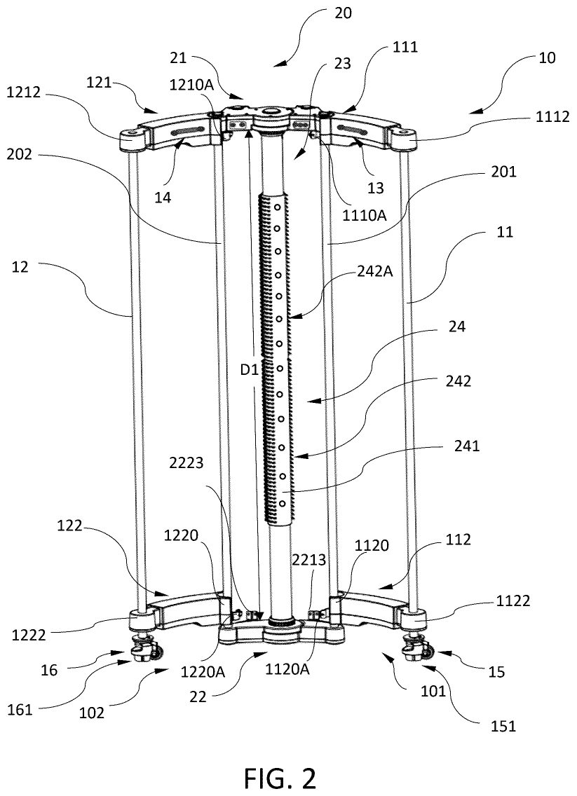

A far infrared rolling back healthcare massage device (as shown in FIG. 2) according to a preferred embodiment of the present invention is provided, which is configured to be equipped by a human user to conduct spinal exercise, back massage and acupuncture/moxibustion with non-invasive and painless therapy with respect to the Governor vessel, the Jia-Ji acupoints and the bladder meridian by himself or herself. The rolling back method of the far infrared rolling back healthcare massage device is self-helped and natural, wherein the term “self-helped” refers to the far infrared rolling back healthcare massage device that requires the human user body's own movement to achieve the effects of spinal exercise and back massage. On the other hand, the conventional artificial and machine massage tools do not require the human user to do anything while the massager applies the artificial massage tool to the human body and the machine massage tool applies massage motions on a stillness human body. Therefore, no artificial and machine massage tool can substitute or replace the present invention that requires the human user to exercise his or her body while receiving massage and stimulation to his or her Governor vessel, Jia-Ji acupoints and/or bladder meridian. IN addition, the term “natural” refers that the far infrared rolling back healthcare massage device of the present invention requires no mechanical power and no chemical aids. It is essential to realize that to achieve the best massage effect with respect to the Governor vessel, Jia-Ji acupoints and bladder meridian, the human body is preferred to strengthen the strength of bone, muscle and ligament at the same time but such strengthening of the strength of bone, muscle and ligament must be done through the human user's own exercises, especially the disc healthcare of the user's spine must be completed by the bending motion of the user's own body.

The far infrared rolling back healthcare massage device of the present invention is adapted for the user to conduct specific spinal according to a rolling back method thereof by self-help to accomplish both “Fitness” and “Healthcare” simultaneously. The “Fitness” concept is achieved by the body exercise conducted by the user. The “Healthcare” concept is achieved by massaging the spine and the three meridians and acupoints in the back of the user through the rolling back massage stem of the far infrared rolling back healthcare massage device under far infrared ray radiation therapy, wherein it not only cares spine for external physical shape and location, as well as internal physiological functions, but also regulates and promotes physiological activities of the body comprehensively. So, “Fitness” and “Healthcare” work together to achieve the overall healthcare effects of the human body.

In particular, the “healthcare” is accomplished of the “hardware” that is the far infrared rolling back healthcare massage device of the present invention which has a trinity configuration for:
(i) rolling back massage;
(ii) acupuncture with non-invasive and painless therapy; and
(iii) moxibustion with non-invasive and painless therapy.

The “software” accomplished by the far infrared rolling back healthcare massage device is a trinity healthcare of the Governor vessel, Jia-Ji acupoints and bladder meridian through the back massage, acupuncture and moxibustion with non-invasive and painless therapy.

In the process of acupuncture and moxibustion on the three meridians and acupoints, the function of the hardware is implemented. When performing massage and acupuncture on each meridian and acupoints, the squatting and rising of the legs drive the movement of the human body to achieve the effects of back massage, acupuncture and moxibustion with non-invasive and painless therapy.

The first healthcare program is the back massage, acupuncture and moxibustion with non-invasive and painless therapy for the spine and Governor vessel. The pathway of the Governor vessel ascends along the spine and enters the brain. While performing healthcare back massage on the spine, acupuncture and moxibustion therapy are also applied on the Governor vessel.

The second healthcare program is the back massage, acupuncture and moxibustion with non-invasive and painless therapy for Jia-Ji acupoints to strengthen the reflex function of the central nervous system and activate the regeneration of central neurons through Jia-Ji acupoint. The spinal cord is not only the pathway of nerve conduction but also the center of many reflex activities. Jia-Ji acupoints are located at the spinous process of the spine, and there are spinal nerve roots under the acupoints. In which, the reflex function is the regular response of the human body to internal and external environmental stimuli with the participation of the central nervous system. Jia-Ji acupoints have the effect of regulating the central nervous system and peripheral nervous system. Therefore, with penetration and thermal effects of far infrared ray, stimulating the Jia-Ji acupoints can promote the reflex function of the central nervous system and achieve the effect of activating the regeneration of motor neurons.

The third healthcare program is the back massage, acupuncture and moxibustion with non-invasive and painless therapy for the bladder meridian. There are twelve Back-Shu acupoints on the first sideline of bladder meridian, located close to the Governor vessel. Back-Shu acupoints are connected with viscera and organs, which are directly infused by the functions playing of viscera and organs, and the Back-Shu acupoints also directly affect the physiological functions of viscera and organs too. In addition, back massage of the bladder meridian can coordinate and promote the relationship and function between viscera and organs, and the Governor vessel synergistically can promote kidney function, spinal cord and brain connection. Therefore, the functions of the central nervous system and internal organs are promoted.

In view of above, the “software” concept of the far infrared rolling back healthcare massage device is to back massage, acupuncture and moxibustion with non-invasive and painless therapy for the Governor vessel, Jia-Ji acupoints and bladder meridian, that covers the most important physiological activities of the body. The Governor vessel joins Bladder meridian and connects the kidneys. Governor vessel enters the brain of the head upwards from the tailbone of the spine. Bladder meridian starts from outside the inner canthus of the eyes of the face and connects to the brain from the top of the head. Then separate left and right and go down the back of the spine, along the inner side of the scapula, on both sides of the spine, to the waist, go deep into the body cavity from the paraspinal muscles, connect with the kidneys, and belong to the bladder.

The back massage, acupuncture and moxibustion for the Governor vessel, Jia-Ji acupoints and bladder meridian of the human user are performed under far infrared ray. With the effects of far infrared ray, it closely connects the functions of the kidneys, spinal cord and brain. These physiological activities have important medical significance.

The above three health care solutions not only reveal Dr. Eva Mezey's research discovery that cells from bone marrow can enter the human brain and produce new neurons and other types of brain cells. physiological mechanism, and this scientific discovery was realized clinically. It has practical significance in promoting human health and preventing diseases.

Referring to FIG. 2, according to a preferred embodiment of the present invention, the far infrared rolling back healthcare massage device is arranged for a human user to perform a flexing and extending movement by legs squatting and rising and to back massage, acupuncture and moxibustion with non-invasive and painless therapy at the same time. The far infrared rolling back healthcare massage device, which can also be considered as a flexing and extending exercising apparatus, comprises a support frame 10, a rolling back apparatus 20 and a far infrared ray generator 30. It is appreciated that users of all ages can perform crouch or squat movements with respect to the far infrared rolling back healthcare massage device of the present invention.

Optionally, the support frame 10 further comprises a left handle 11 and a right handle 12 which are elongated bars respectively provided at a left side and a right side thereof and adapted for the left hand and the right hand to hold while conducting spinal exercise with respect to the rolling back apparatus 20.

The rolling back apparatus 20 which is rotatably supported by the support frame 10 comprises an upper supporter 21, a lower supporter 22, a circular and elongated rolling back massage stem 23, and a massaging arrangement 24. The upper supporter 21 and the lower supporter 22 are spacedly mounted by the support frame 10 to have an exercise distance DI therebetween, as shown in FIG. 2. The rolling back massage stem 23 is securely and vertically supported between the upper supporter 21 and the lower supporter 22 and has a front side and a rear side.

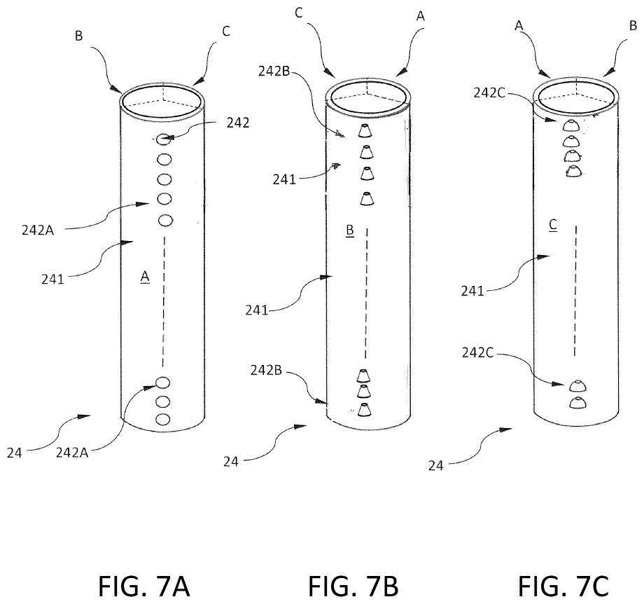

Referring to FIG. 6, the massaging arrangement 24 comprises a tubular and elongated body 241 rotatably mounted around the rolling back massage stem 23, defining a circular installation chamber 240 between an outer surface of the rolling back massage stem 23 and an inner surface of the massaging arrangement 24, wherein the massaging arrangement 24 is extended along a central portion of at least one of the front side and rear side of the rolling back massage stem 23 and a plurality of massaging elements 242 protruded or non-protruded on the body 241 and oriented for selectively touching, rubbing and kneading against a back of a user when the user is performing the flexing and extending movement by leg squatting and rising with the back of the user touching and pushing rearwards against the massaging arrangement 24.

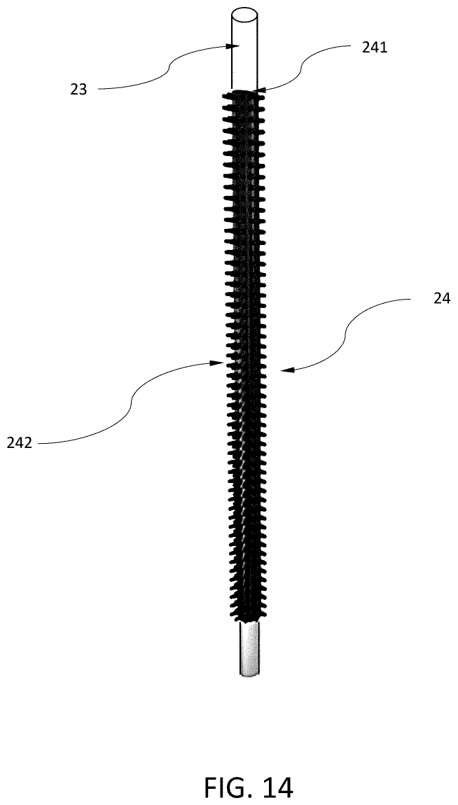

Referring to FIG. 2 and FIG. 14, the massaging elements 242 are embodied as protruding pillars or non-protruding surface having a circular or ellipse cross section. The pillar shape massaging elements 242 are arranged in form of at least one vertical row with gaps between them which corresponding meridian and acupoint.

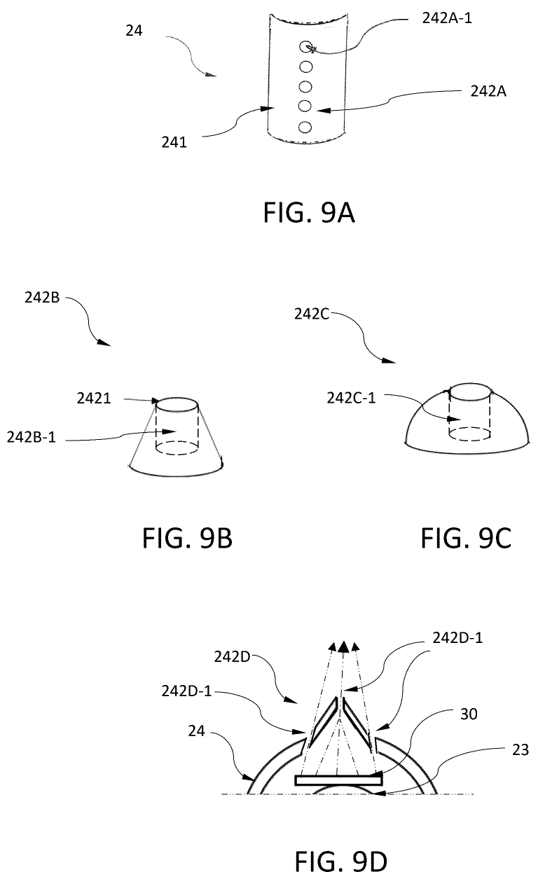

According to the general height of human bones and spine, for illustration and exemplary purposes, the rolling back massage stem 23 can be made of stainless-steel tube and a height of 1.8 m. The massaging arrangement 24 has a height of 0.9 m, a distance from a bottom of the massaging arrangement 24 and a lower end of the rolling back massage stem 23 is 0.6 m and a distance between a top of the massaging arrangement 24 and an upper end of the rolling back massage stem 23 is 0.3 m. The massaging elements are made of ceramic material. A plastic sleeve is arranged on the ceramic massaging elements to fit with the massaging arrangement 24 as shown in FIG. 8.

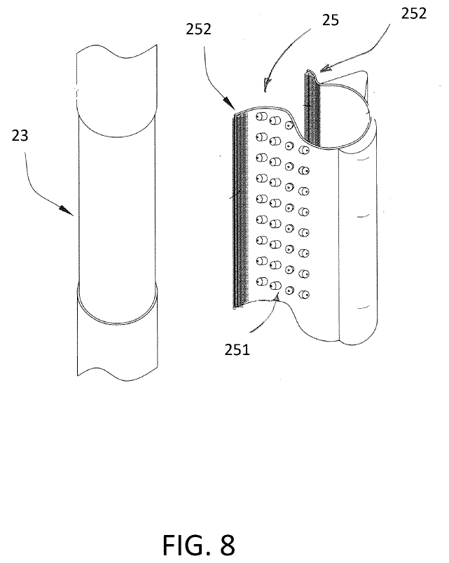

According to the preferred embodiment, referring to FIG. 7A to FIG. 7C, three massaging elements of the massaging arrangement 24 is illustrated, wherein the massaging arrangement 24 is extended along at least a central portion for a predetermined length of the rolling back massage stem 23 and has a first longitudinal portion A, a second longitudinal portion B and a third longitudinal portion C, each having an included angle of generally 120 degrees. The first longitudinal portion A of the massaging arrangement 24 has a column and a plurality of first massaging elements 242A spacedly and longitudinal on the body 241. The second longitudinal portion B of the massaging arrangement 24 has at least a column and a plurality of second massaging elements 242B protruded spacedly and longitudinal on the body 241. The third longitudinal portion C of the massaging arrangement 24 has a column and a plurality of third massaging elements 242C protruded spacedly and longitudinal on the body 241. The first, second and third massaging elements 242A, 242B and 242C are oriented for selectively touching, rubbing and kneading against a back of a user when the user is performing the flexing and extending movement by leg squatting and rising with the back of the user touching and pushing rearwards against the massaging arrangement 24.

According to the preferred embodiment, referring to FIG. 6 and FIG. 7A-FIG. 7C, the rolling back massage stem 23 is rotatably supported between the upper supporter 21 and the lower supporter 22 in such a manner that the user may rotate the massaging arrangement 24 with respect to the rolling back massage stem 23 to selectively adjust between a first position, a second position and a third position, wherein each rotation adjustment is preferred to be set as 120°. Accordingly, in the first position, the first longitudinal portion A of the massaging arrangement 24 is rotated and adjusted facing frontwards as shown in FIG. 7A, wherein in the second position, the second longitudinal portion B of the massaging arrangement 24 is rotated and adjusted facing frontwards as shown in FIG. 7B, wherein in the third position, the third longitudinal portion C of the massaging arrangement 24 is rotated and adjusted facing frontwards as shown in FIG. 7C.

According to an alternative mode of the preferred embodiment, referring to FIG. 6 and FIG. 7A-FIG. 7C, the rolling back massage stem 23 is rotatably supported between the upper supporter 21 and the lower supporter 22 and the massaging arrangement 24 is affixedly mounted around the rolling back massage stem 23, such that the user may rotate the elongated rolling back massage stem 23 to selectively adjust between a first position, a second position and a third position, wherein in the first position, the first longitudinal portion A of the massaging arrangement 24 is rotated and adjusted facing frontwards as shown in FIG. 7A, wherein in the second position, the second longitudinal portion B of the massaging arrangement 24 is rotated and adjusted facing frontwards as shown in FIG. 7B, wherein in the third position, the third longitudinal portion C of the massaging arrangement 24 is rotated and adjusted facing frontwards as shown in FIG. 7C.

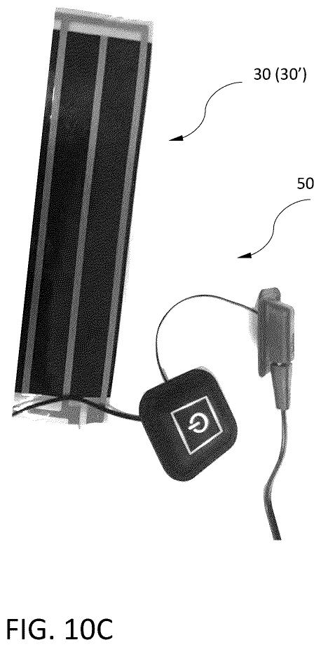

The far infrared ray generator 30, referring to FIG. 10A to 10C, is arranged in the installation chamber 240 between a center rod 233 of the rolling back massage stem 23 and the massaging arrangement 24 and configured to generate at least one far infrared ray, embodied having a wavelength 4-15 μm, with a predetermined frequency radiating towards a treatment space around the rolling back massage stem 23 while the user is exercising with the far infrared rolling back massage device.

According to the preferred embodiment, the far infrared ray generator 30 is a panel or other type far-infrared ray generating member 30′, as shown in FIG. 10A and FIG. 10C, electrically connected to a power source 50 and mounted in front of the rolling back massage stem 23, embodied as a center rod, in the installation chamber 240 between the rolling back massage stem 23 and the massaging arrangement 24, such that the far infrared ray generator 30 is facing frontwards, either the first longitudinal portion A, the second longitudinal portion B or the third longitudinal portion C of the massaging arrangement 24 which is rotated to face frontward, wherein the far-infrared ray generated by the far-infrared ray generating member 30′ is emitting frontwards to the first, second or third massaging elements 242A, 242B or 242C of the corresponding first, second or third longitudinal portion A, B or C.

According to the alternative mode of the preferred embodiment, the far infrared ray generator 30 is a far-infrared ray generating coat 30″, as shown in FIG. 10B, arranged around the central portion of the rolling back massage stem 23 and positioned in the installation chamber 240 between a center rod 233 of the rolling back massage stem 23 and the massaging arrangement 24, such that far-infrared rays are emitting toward the first longitudinal portion A, the second longitudinal portion B and the third longitudinal portion C of the massaging arrangement 24, no matter the rolling back massage stem 23 is rotated to have either the first longitudinal portion A, the second longitudinal portion B or the third longitudinal portion C of the massaging arrangement 24 faces frontwards. Either the far-infrared ray generating member 30′ or the far-infrared ray generating coating 30″ is configured to emit far-infrared radiation. The far infrared ray generator 3 is electrically connected to a power source 50, as shown in FIG. 10B and FIG. 10C.

The left handle 11 and the right handle 12 are optional configuration, wherein the far infrared rolling back healthcare massage device may not comprise the left and right handles 11, 12. However, when the left handle 11 and the right handle 12 are installed, according to the preferred embodiment, the left handle 11 and the right handle 12 are extending vertically along with the length of the rolling back massage stem 23 in a parallel manner with a distance adapted for the user to hold thereon with his or her left respectively while the user is performing the flexing and extending movement by leg squatting and rising with the back of the user touching and pushing rearwards against the massaging arrangement 24.

According to the preferred embodiment, referring to FIG. 2 and FIG. 6, the rolling back apparatus 20 further comprises a pair of first and second mounting posts 201, 202 fixedly mounted between the upper supporter 21 and the lower supporter 22 parallelly, such that the first mounting post 201, the second mounting post 202, the upper supporter 21, the lower supporter 22 form a rectangular rigid configuration to securely support the rolling back massage stem 23 between the first and second mounting posts 201, 202 in a balance manner. In other words, the width of the upper and second supporters 21, 22 significantly increases the distance between the rolling back massage stem 23 with respect to each of the first and second mounting posts 202, 202 so as to increase a force moment of the rolling back massage stem 23 to ensure the rolling back massage stem 23 is strong and strengthen enough to bear the pushing force of the back of the user to be applied to the rolling back massage stem 23.

In particular, the support frame 10 further comprises a pair of first upper supporting arm 111 and first lower supporting arm 112 and a pair of second upper supporting arm 121 and second lower supporting arm 122, wherein the first upper supporting arm 111 and the first lower supporting arm 112 are pivotally coupled with respect to an upper end and a lower end of the first mounting post 201 and the second upper supporting arm 121 and the second lower supporting arm 122 are pivotally coupled with respect to an upper end and a lower end of the second mounting post 202.

It is appreciated that the first mounting post 201 supports the first upper supporting arm 111, the first lower supporting arm 112 and the left handle 11 to form a left support frame 101 for the rolling back apparatus 20, wherein the left handle 11 is also further extended outwards from the rolling back massage stem 23 by the first upper supporting arm 111 and the first lower supporting arm 112. Similarly, the second mounting post 202 supports the second upper supporting arm 121, the second lower supporting arm 122 and the right handle 12 to form a right support frame 102 for the rolling back apparatus 20, wherein the right handle 12 is also further extended outwards from the rolling back massage stem 23 by the second upper supporting arm 121 and the second lower supporting arm 122. Correspondingly, the left support frame 101 and the right support frame 102 also substantially support the rolling back apparatus 20 in a central position therebetween in a balance manner.

Preferably, each of the first and second upper and lower supporting arms 111, 112, 121, 122 is an curved arm so that the left handle 11 and the right handle 12 are curvedly extended from the first and second mounting posts 201, 202 respectively and arranged in frontward positions in related to the rolling back massage stem 23 so as to provide a more rigid triangular arrangement and ensure the left handle 11 and the right handle 12 are within hand reachable positions of the left hand and the right hand of the user to hold thereon respectively while the user is pushing his or her back against the rolling back massage stem 23 during the crouch or squat movements of the user.

By rotating the left support frame 101 and the right support frame 102 about the first mounting post 201 and the second mounting post 202 respectively can also adjust the distance between each of the left handle 11 and the right handle 12 with respect to the rolling back massage stem 23.

The arrangement of the frontward positions of the left handle 11 and right handle 12 with respect to rolling back massage stem 23 constructs a mutual force balancing configuration to the user, wherein the user can user his or her left and right hands hold and push against the left handle 11 and the right handle 12 that helps to push his or her back against the rolling back massage stem 23 rearwards. At the same time, the pushing of the user's hands against the left and right handles 11, 12 and the user's back against the rolling back massage stem 23 also further reinforce the arrangement of the support frame 10 and the rolling back apparatus 20 of the far infrared rolling back healthcare massage device of the present invention. In other words, the user himself or herself also contributes a balancing factor to the device while the device supports the user to conduct spinal exercise therewith simultaneously and collaboratively.

Referring to FIG. 2, according to a preferred embodiment of the present invention, the far infrared rolling back healthcare massage device is to provide choice that allow the user to perform acupuncture therapy in a still state that suitable for ALS patients and patients with limited mobility to perform acupuncture therapy while seated in front of rolling massage stem. This treatment is similar to treatment in an acupuncture clinic, but is non-invasive, painless self-care at home.

Each of the first and second upper and lower supporting arms 111, 112, 121, 122 comprises a support bracket 1111, 1121, 1211, 1221 and an arm 1112, 1122, 1212, 1222 having one end coupled with the corresponding support bracket 1111, 1121, 1211, 1221 and another end connected with one end of the corresponding left handle 11 or right handle 12.

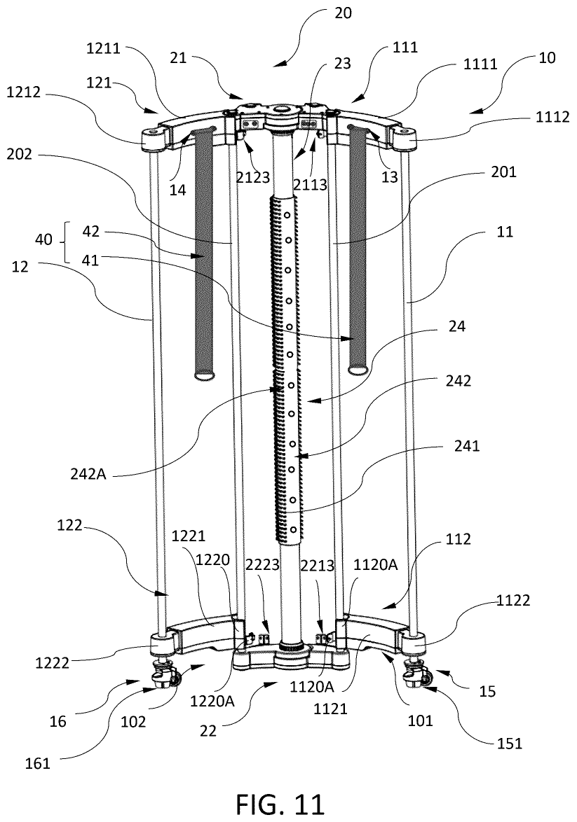

According to the preferred embodiment, referring to FIG. 2 and FIG. 11, the far infrared rolling back massage device further comprises a safety apparatus 40 coupled with the support frame for the user to secure while doing the flexing and extending movement with respect to the massaging arrangement. The safety apparatus 41 comprises a pair of safety belts 41, 42. Correspondingly, each of the first and second support members 211, 212 comprises a connector element 13, 14 for fastening one end of the corresponding safety belt 41, 42 thereto. Specifically, the connector elements 13, 14 are provided on front sides of the first and second upper support brackets 1111, 1211 respectively. Accordingly, the safety belts 41, 42 of the safety apparatus 40 arranged at the first and second support brackets 1111, 1211 of the support frame 10 are arranged within a hand reaching distance from the rolling back massage stem 23, such that the user can put the loop of the safety belts 41, 42 on the upper arms thereof to prevent the user from falling to the ground during conducting the exercise and healthcare massage.

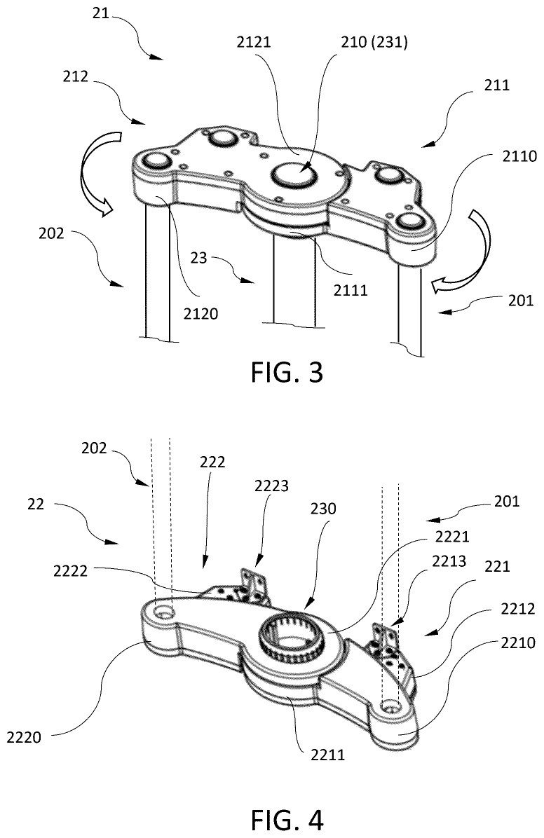

Referring to FIG. 3, the upper supporter 21 comprises a pair of first and second support members 211, 212. Each of the first support member 211 and the second support member 212 has a circular pivot joint 2111, 2121. The pivot joints 2111, 2121 are pivotally connected together through a pivot shaft unit 210 in such a manner that the first support member 211 and the second support member 212 are able to be rotated with respect to each other about the pivot shaft unit 210.

An upper end of the rolling back massage stem 23 is securely connected to the pivot shaft unit 210. Upper ends of the first mounting post 201 and the second mounting post 202 are fixedly connected to distal ends of the first support member 211 and the second support member 212 respectively, such that by rotating the first and second support members 211, 212 with respect to each other about the pivot shaft unit 210, the first mounting post 201 and the second mounting post 202 are symmetrically rotated about the rolling back massage stem 23 at the same time to adjust the included angle and distance between the first and second mounting posts 201, 202 with respect to the rolling back massage stem 23.

It is worth mentioning that the top end 231 of the rolling back massage stem 23 can also be configured and functioned as the pivot shaft unit 210 to pivotally connect the first and second pivot joints 2111, 2121 with each other.

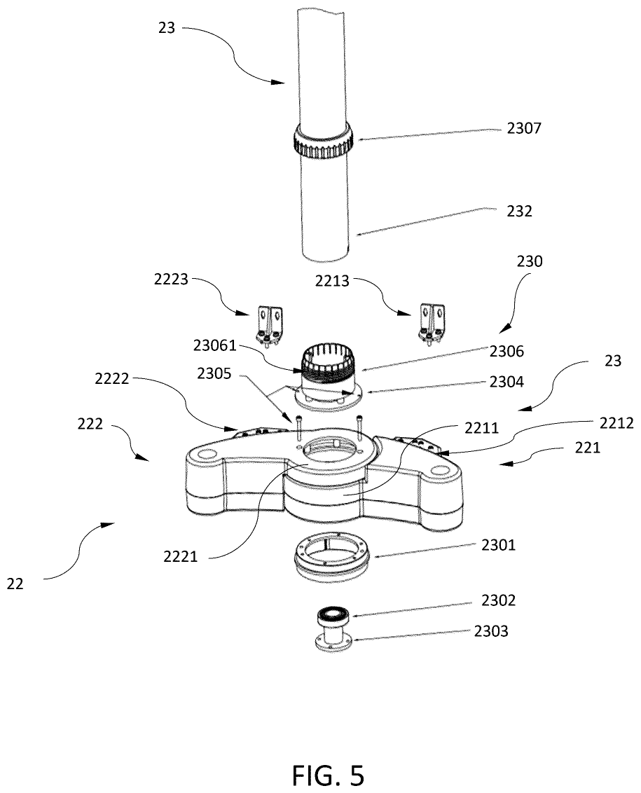

Referring to FIG. 4, the lower supporter 22 comprises a pair of first and second support arms 221, 222. The first support arm 221 has a circular first pivoting joint 2211 and the second support arm 222 has a circular f second pivoting joint 2221. The first and second pivoting joints 2211, 2221 are pivotally connected together through a pivot stem base 230 in such a manner that the first support arm 221 and the second support arm 222 are able to be rotated with respect to each other about the pivot stem base 230. Lower ends of the first mounting post 201 and the second mounting post 202 are fixed connected to distal ends of the first support arm 221 and the second support arm 222 respectively, such that by rotating the first and second support arms 221, 222 with respect to each other about the pivot stem base 230, the first mounting post 201 and the second mounting post 202 are symmetrically rotated about the pivot stem base 230 (as well as the rolling back massage stem 23) at the same time to adjust the included angle and distance between the first and second mounting posts 201, 202 with respect to the rolling back massage stem 23.

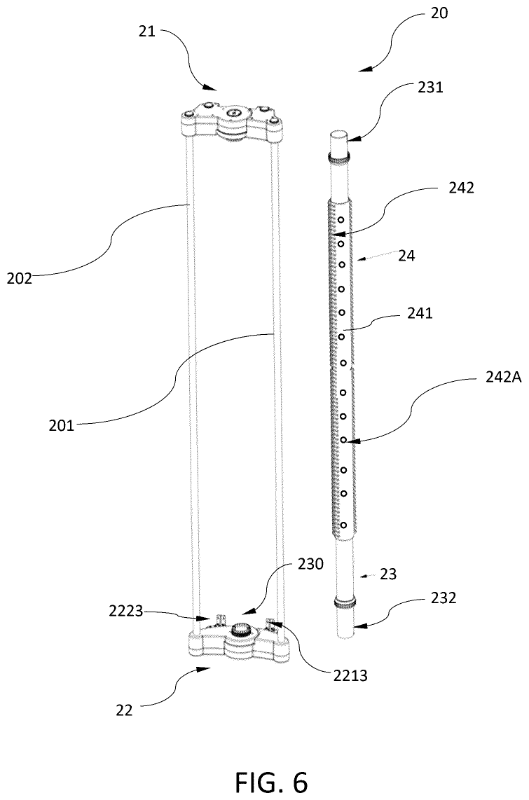

Referring to FIG. 4 and FIG. 5, the lower end 232 of the rolling back massage stem 23 is detachably connected to the pivot stem base 230. The pivot stem base 230 comprises a connecting element 2301 mounted in the first pivoting joint 2211 and configured to rotatably connect the first pivoting joint 2211 of the first support arm 221 with the second pivoting joint 2221 of the second support arm 222, a bearing element 2302 rotatably mounted on a bearing base 2303 fastened to a bottom of the first pivoting joint 2211 of the first support arm 221 for allowing the first and second pivoting joints 2211, 2221 to rotate with each other coaxially, a base mount 2304 fastened to an upper side of the second pivoting joint 2221 through a pair of fastening elements 2305, a tubular stem base 2306 mounted on top of the base mount 2304 and linked with the bearing element 2302, and a fastening ring 2307 movably and rotatably disposed on a lower portion of the rolling back massage stem 23. To vertically connect the lower end 232 of the rolling back massage stem 23 to the lower support 22, the lower end 232 of the rolling back massage stem 23 is inserted into the stem base 2306 and the fastening ring 2307 is screwed to a threaded portion 23061 of the stem base 2306 so as to tighten the fastening ring 2307 with the stem base 2306 and press against the lower end 232 of the rolling back massage stem 23 so as to fasten the rolling back massage stem 23 in a vertical position while the rolling back massage stem 23.

Referring to FIG. 3 to FIG. 4, it is appreciated that the pivot shaft unit 210 can also be embodied as the pivot stem base 230 to rotatably couple the first pivot joint 2111 of the first support member 211 and the second pivot joint 2121 of the second support member 212 and mount the upper end 231 of the rolling back massage stem 23 with the upper supporter 21.

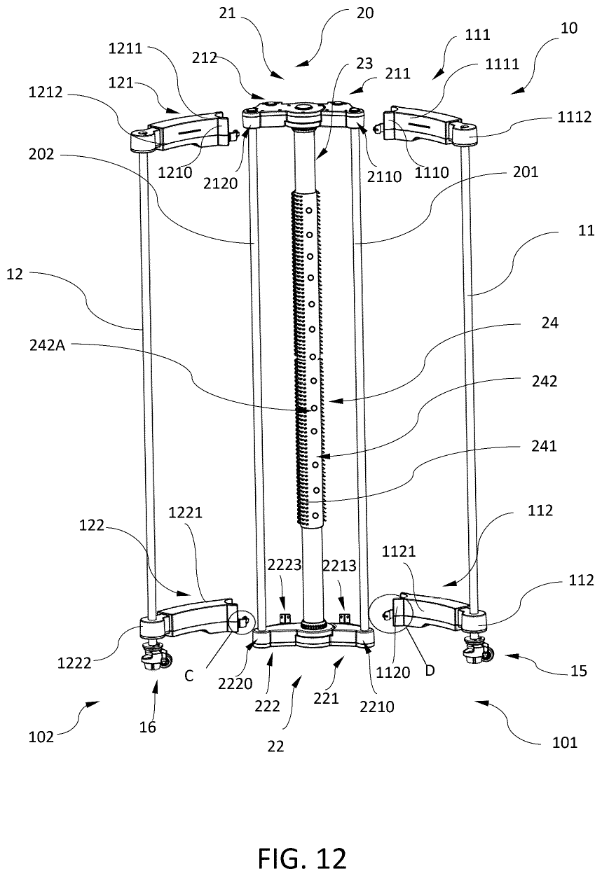

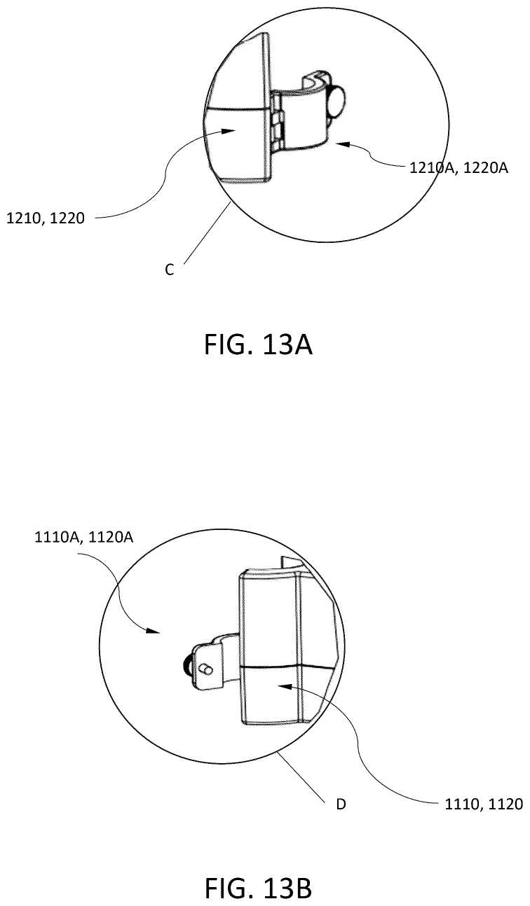

Referring to FIG. 12, each of the first and second support members 211, 212 has a circular shaped pivot end portion 2110, 2120, opposing the pivot joint 2111, 2121, such that upper ends of the first and second mounting posts 201, 202 are fixedly connected to pivot end portions 2112, 2122 of the first and second support members 211, 212 respectively and coaxially (as shown in FIG. 3). Each of the first and second support arms 221, 222 has a circular shaped pivoting end portion 2210, 2220, opposing the pivoting joint 2211, 2221, such that lower ends of the first and second mounting posts 201, 202 are fixedly connected to pivoting end portions 2210, 2220 of the first and second support arms 221, 222 respectively and coaxially (as shown in FIG. 4).

Correspondingly, a connecting end of each of the first and second upper support brackets 1111, 1211 and the first and second lower support brackets 1121, 1221 further comprises a semi-circular shaped pivotal joint 1110, 1210, 1120, 1220, having a curvature matching with the pivot end portions 2110, 2120 and the pivoting end portions 2110, 2220, such that the first and second upper supporting arms 111, 121 are coupled with the first and second support members 211, 212 by coaxially sleeving the pivotal joints 1110, 1210 onto the pivot end portions 2110, 2120 respectively and the first and second lower supporting arms 112, 122 are coupled with the first and second support arms 221, 222 by coaxially sleeving the pivotal joints 1120, 1220 onto the pivoting end portions 2210, 2220 respectively, such that the first and second upper supporting arms 111, 121 of the left and right handle 11, 12 are capable of swinging about the first and second mounting posts 201, 202 respectively (as shown in FIG. 2).

Referring to FIG. 4 and FIG. 5, each of the first and second support arms 221 and 222 further comprises a connector 2212, 2222 at a rear side thereof and a lower mount 2213, 2223 secured to the connector 2212, 2222. Similarly, each of the first and second support members 211, 212 also comprises at least an upper mount 2113, 2123 at a rear side thereof, as shown in FIG. 11.

In order to further coupling the left handle 11 and the right handle 12 of the support frame 10 with the rolling back apparatus 20, each of the pivotal joints 1110, 1210, 1120, 1220 hinged with a hinging connector 1210A, 1210A, 1120A, 1220A (as shown in FIG. 12A and FIG. 12B), configured to be fastened with the upper mounts 2113, 2123 and the lower mounts 2213, 2223 respectively (as shown in FIG. 2 and FIG. 11). It is worth mentioning that, in FIG. 2 and FIG. 11, for ease of illustration, the hinging connectors 1120A, 1220A and the lower mounts 2213, 2223 are in unfastened condition which are supposed to be fastened securely when use.

Referring to FIG. 2 and FIG. 11, the lower supporter 22 of the rolling back apparatus 20 can be mounted on an exercise surface such as ground surface and, for facilitating the adjusting of the left handle 11 and right handle 12 of the support frame 10, such as rotating the left handle 11 and the right handle 12 about the first and second mounting posts 201, 202, the support frame 10 further comprises a pair of rolling wheels 15, 16 connected to bottoms of the lower supporting arms 112, 122 respectively for ease of moving on the ground surface.

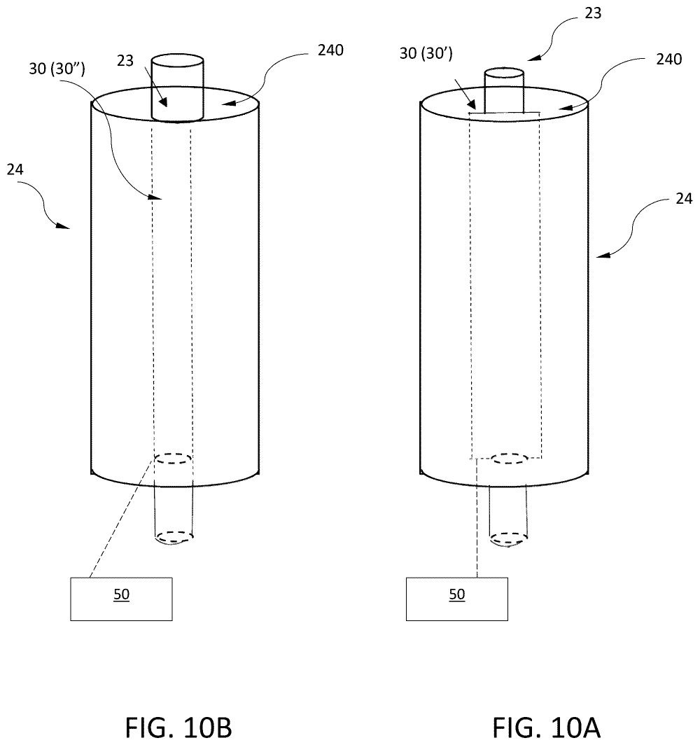

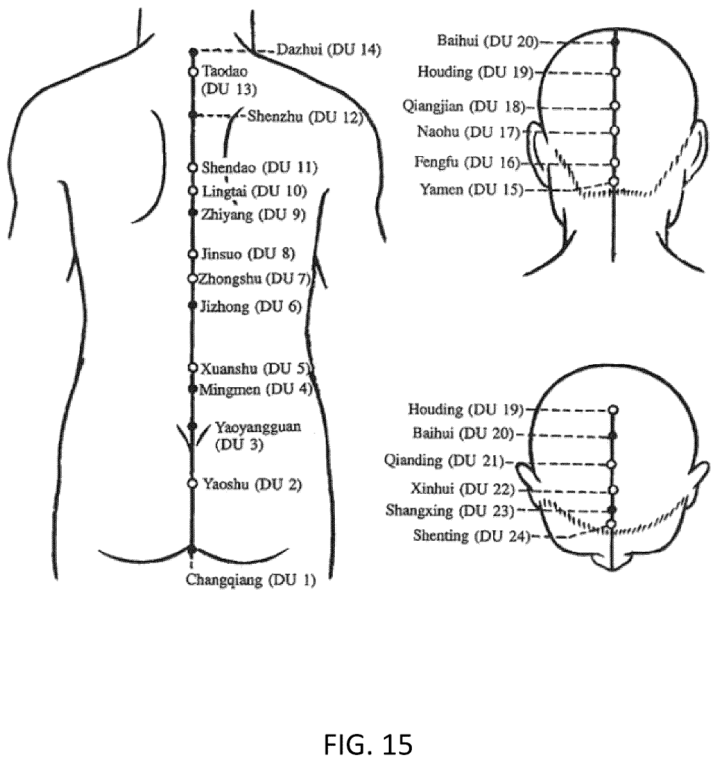

Referring to FIG. 2, FIG. 7A and FIG. 9A, the plurality of first massaging elements 242A is embodied as a plurality of central far-infrared ray channels 242A-1, each of which is a hole formed in the cylindrical surface of the body 241 (as shown in FIG. 9A). The plurality of first massaging elements 242A is arranged in linear manner spacedly to form one column of the central far-infrared ray channels 242A-1 communicating the far infrared ray generator 30 with outside therethrough, wherein a space distance between every two adjacent central far-infrared ray channels 242A-1 (first massaging elements 242A) are arranged corresponding to meridian and acupoint. The far infrared ray radiation emitted from the far infrared ray generator 30 penetrates through the central far-infrared ray channels 242A-1 of the linear column of first massaging elements 242A is adapted to stimulate the Governor vessel, that is the middle line along the central spine of the user, as shown in FIG. 2 and FIG. 15, when the user is performing the flexing and extending movement by leg squatting and rising with Governor vessel of the back of the user touching and pushing rearwards against the body 241 and the first massaging elements 242A of the massaging arrangement 24. Since the first massage elements 242A are the holes formed in body 241 as the central far infrared ray channels 242A-1, the far-infrared ray generated by the far infrared ray generator 30 through the central far infrared ray channels 242A-1 (first massage elements 242A) to the back of the user. It is preferable when the user merely desires to have pressure massage stimulation to his or her Governor vessel. Of course, when the user may also select different portion of his or her back to be massage by performing the flexing and extending movement by leg squatting and rising with the desire portion of the back of the user touching and pushing rearwards against the first massaging elements 242A of the massaging arrangement 24.

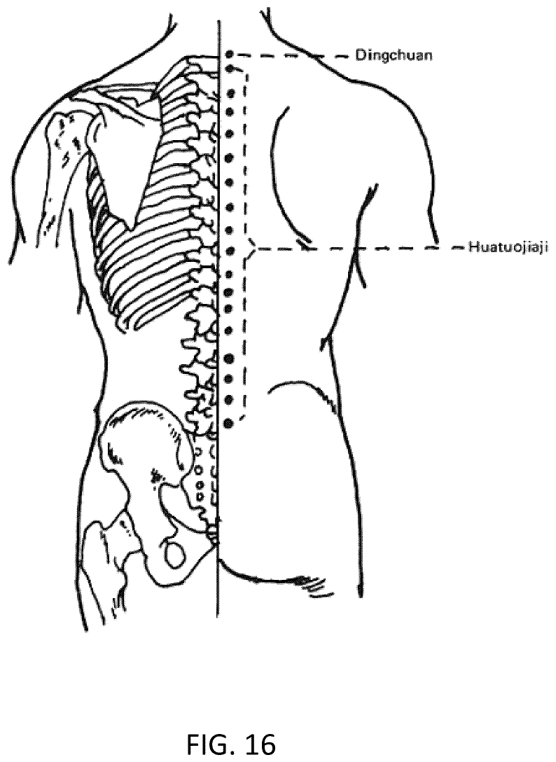

Referring to FIG. 2, FIG. 7B and FIG. 9B, at least a column of second massaging elements 242B, made of ceramic material, is a tubular body in conical shape defining an axial through hole as a central far-infrared ray channel 242B-1 coaxially (as shown in FIG. 9B) for communicating the far infrared ray generator 30 with outside. Each of the second massaging elements 242B are protruding heads integrally and radically protruded along the body 241 of the massaging arrangement 24 in a spaced manner and in a specific pattern. As shown in FIG. 7B, each of the second massaging elements 242B is protruded on the massaging arrangement 24 linearly and spacedly. The gap between massage elements corresponding meridian and acupoint. The arrangement as well as the size and shape of the each of the massaging elements are configured to provide stimulating effect to a human body when a pressure is applied thereagainst by the human body. The each of second massaging elements 242B are adapted to stimulate the 34 acupoints of Jia-Ji acupoints (17 acupoints on each of the left side and the right side of the Governor vessel) in the back of the human user, as shown in FIG. 16, when the user is performing the flexing and extending movement by leg squatting and rising with Jia-Ji acupoints and bladder meridian on the back of the user touching and pushing rearwards against the second massaging elements 242B of the massaging arrangement 24. The far-infrared ray generated by the far infrared red ray generator 30 penetrates through the central far-infrared ray channel 242B-1 to precisely and concentratedly apply on the Jia-Ji acupoints with nozzle effect to the back of the user pressing against the corresponding second massaging elements 242B to obtain a non-invasive and painless acupuncture effect.

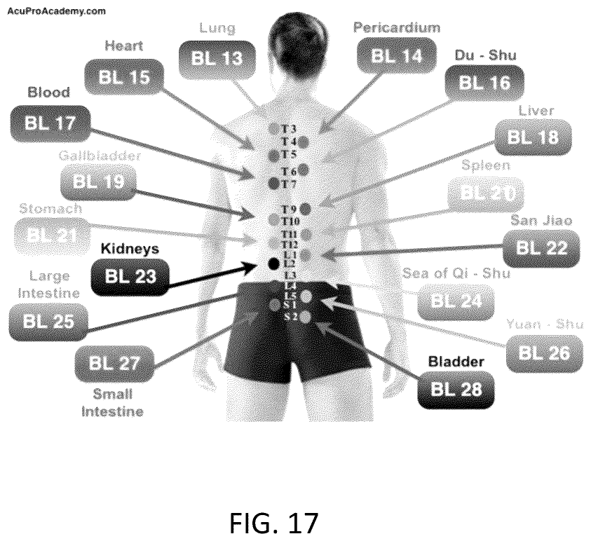

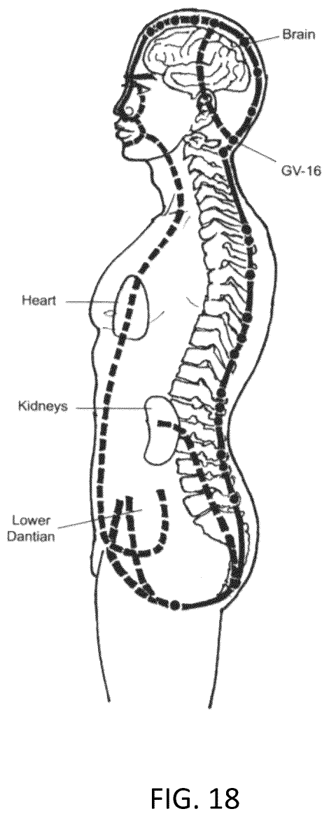

Referring to FIG. 2, FIG. 7C and FIG. 9C, each of the plurality of third massaging elements 242C, made of ceramic material, is a tubular body in semi-ellipsoid shape defining an axial through hole as a central far-infrared ray channel 242C-1 coaxially (as shown in FIG. 9C) for communicating the far infrared ray generator 30 with outside. One column of the third massaging elements 242C are protruded heads integrally and linearly protruded along the body 241 of the massaging arrangement 24 in a spaced manner and in a specific pattern. As shown in FIG. 9C. The gap between massage elements corresponding meridian and acupoint. The linear column of the third massaging elements 242C is adapted to stimulate Bladder meridian as shown in FIG. 17 and, selectively, the physiological route of energy operation of kidney function, spinal cord and brain of the user as shown in FIG. 18, when the user is performing the flexing and extending movement by leg squatting and rising with the Bladder meridian of the back of the user touching and pushing rearwards against the third massaging elements 242C of the massaging arrangement 24. The far-infrared ray generated by the far infrared red ray generator 30 penetrates through the central far-infrared ray channel 242C-1 to precisely and concentratedly apply on the acupoints along the Bladder meridian or, selectively, the physiological route of energy operation of kidney function, spinal cord and brain of the user with nozzle effect of the back of the user pressing against the corresponding third massaging elements 242C to obtain a non-invasive and painless acupuncture effect.

It is worth mentioning that the massaging elements 242A, 242B and 242C and the arrangement thereof as described above are based on spinal structure and meridians and acupoints for exemplary and illustration.

Referring to FIG. 9D, an alternative mode of the structure of the massaging element 242 is illustrated, wherein the massaging element is made of ceramic material and each of a plurality of fourth massaging elements 242D is a hollow body (can be in conical shape or semi-ellipsoid shape) integrally protruded on the rolling back massage stem 23, wherein a tip of each of the fourth massaging elements has a hole functioning as the far-infrared ray channel 242D-1, such that the far infrared rays generated from the far infrared ray generator 30 mounted on the rolling back massage stem 23 concentrate to emit through the far-infrared ray channel 242D-1 to enhance the nozzle effect and stimulation effect.

It is worth mentioning that the number of the far-infrared ray channels 242A-1, 242B-1, 242C-1, 242D-1 of each of the first, second, third and fourth massaging elements 242A, 242B, 242C, 242D is not limited to one that there can be two more far-infrared ray channels 242A-1, 242B-1, 242C-1, 242D-1 formed around the first, second, third and fourth massaging element 242A, 242B, 242C, 242D. Referring to FIG. 9D, an example is illustrated, wherein two or more far-infrared ray channels 242D-1 are formed around the fourth massaging element 242D inclinedly, so that two or more far-infrared rays are able to emit therethrough to enhance the far infrared stimulation.

In other words, the first, second, third or fourth massaging element 242A, 242B, 242C or 242D provides a strengthen reaction force to the user while the back of the user push rearward and pressing against the massaging elements 242A, 242B, 242C, 242D for enhance stimulation to the Governor vessel, the Jia-Ji acupoints and the Bladder meridian of the user with non-invasive and painless acupoint therapy.

In addition, the far-infra red rays emitted through the first, second, third or fourth far-infra red ray channel 242A-1, 242B-1, 242C-1, 242D-1 provides a non-invasive and painless acupuncture therapy with respect to the Governor vessel, the Jia-Ji acupoints and the Bladder meridian of the user and the heat produced by the far-infra red rays significantly provide a direct moxibustion effect at the same time. According to traditional Chinese medicine theory, the application of moxibustion heat to specific acupuncture points helps to promote the smooth flow of qi and blood in the body, thereby restoring balance and health. It is believed that moxibustion can invigorate the flow of qi, expel cold and dampness from the body, and strengthen the body's yang energy. It is often used to treat conditions such as pain, digestive disorders, menstrual irregularities, and to support general health and well-being.

During exercise, the back of the user press against the first, second, third or fourth massaging elements 242A, 242B, 242C, 242D substantially position at or even press against the first, second, third or fourth far-infrared ray channels 242A-1, 242B-1, 242C-1 or 242D-1, that also allows the far-infrared rays generated by the far-infrared generator 30 to precisely and concentratedly apply at the acupoints positioned at the first, second, third or fourth far-infrared ray channels 242A-1, 242B-1, 242C-1 or 242D-1 to achieve more precise and effective stimulation than other conventional methods.

n addition, the far infrared ray generator 30 may further comprise a controller to control the intensity and strength of the far-infrared ray being generated and the heat produced. It is preferred to be set as multiple stages, for example a low stage, a medium stage and a high stage.

FIG. 8 illustrates an alternative mode of the rolling back massaging arrangement which comprises a massaging sleeve 25 detachably coupled along the rolling back massage stem 23. A rolling back massaging portion 251 is formed at an outer circumferential surface of the massaging sleeve 25 to match said rolling back massage stem, wherein columns of the massaging elements 242B, 242C, 242D as described above are provided on the rolling back massaging portion 251. Therefore, the massaging sleeve 252 is detachably coupled at the rolling back massaging stem 23 at the mid-portion thereof to orient the corresponding three massaging element for touching, rubbing and/or kneading on the user's back.

In addition, the massaging sleeve 25 further has two detachable edges 252 to allow the massaging sleeve 25 to be selectively detached and re-coupled from an outer surface of the rolling back massage stem 23.

It is worth mentioning that, the left handle 11 and right handle 12 may be installed in addition to allow both hands of the user to hold on respectively while performing the flexing and extending movement and allow the user to push the left handle 11 and right handle 12 to generate a reaction force rearwards to push the back of the user against the massaging arrangement 24, 24A so as to self-apply a massaging pressure on a portion of the back of the user where pushing against the rolling back massage stem for back massaging.

It is appreciated that the vertical extending arrangement of the rolling back massaging stem 23, 23A and the left and right handles 11, 12 in parallel manner from the ground surface to approximately the height of an adult user allow users of all ages can perform crouch or squat movements utilizing the far infrared rolling back healthcare massage device of the present invention.

As shown in FIG. 2, the support frame 10 comprises an upper frame 11 and a lower frame 12, wherein the upper frame 11 is supported above the lower frame 12 at a fixed distance there between. The support frame 10 defines a front side thereof, wherein the user stands at the front side of the support frame 10. In one embodiment, the support frame 10 is a stationary frame, wherein the upper frame 11 and the lower frame 12 are affixed on a wall surface to retain the distance between them. Preferably, each of the upper frame 11 and the lower frame 12 has an elongated structure and defines two outer ends.

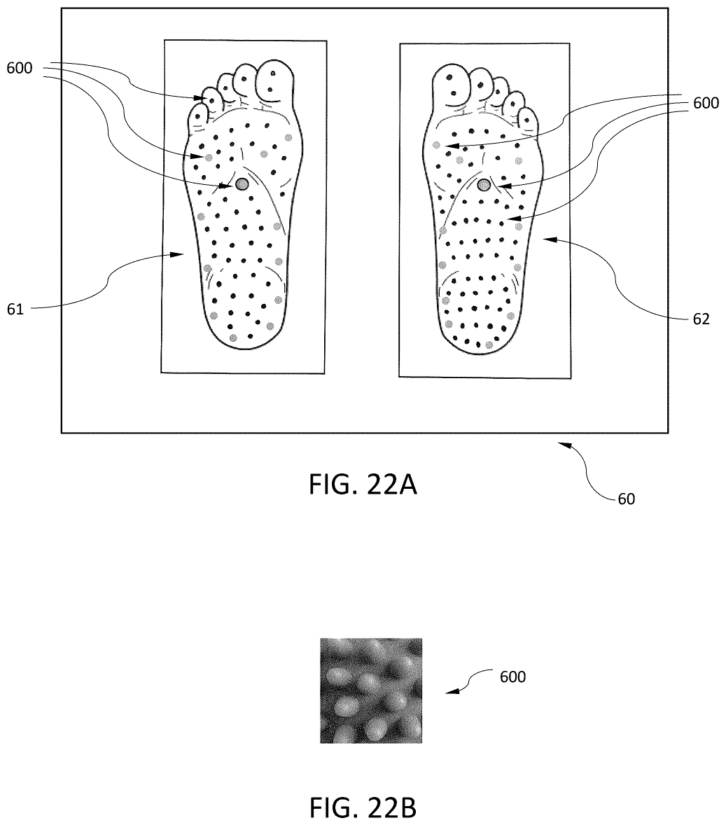

Based on the arrangement of the far infrared rolling back healthcare massage device, referring to FIG. 21, the user may perform the following steps to execute a rolling back method:
(a) Arrange the elongated rolling back massage stem 23 securely and vertically supported by the support frame 10 on an exercise surface and switch on the far infrared ray generator 30 to emit a far infrared ray, which is provided along the rolling back massage stem 23, towards a treatment space (i.e. the space surrounding by the rolling back apparatus 20 and the support frame 10) of the far infrared rolling back healthcare massage device.
(b) Start from a leg squatting position by the user within the treatment space while a coccyx portion along a Governor vessel line of the back of the user pushing against a facing side of the rolling back massage stem 23.
(c) Gradually rise up from the leg squatting position to a rising position by the user while a lumbar vertebra portion, a thoracic vertebra portion and a seventh cervical vertebra portion of the back of the user pushing against the facing side of the rolling back massage stem 23 in sequence along the Governor vessel line joining the coccyx portion, the lumbar vertebra portion, the thoracic vertebra portion, and the seventh cervical vertebra portion of the back of the user.
(d) Gradually squat down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the Governor vessel line joining the coccyx portion, the lumbar vertebra portion, the thoracic vertebra portion, and the seventh cervical vertebra portion of the back of the user.
(e) Repeat the step (c) and the step (d) for corresponding time periods in sequence.
(f) Start from the leg squatting position by the user while the coccyx portion along each of the two lines of Jia-Ji acupoints of the back of the user pushing against the facing side of the rolling back massage stem 23.
(g) Gradually rise up from the leg squatting position to the rising position by the user while the lumbar vertebra portion, the thoracic vertebra portion and the seventh cervical vertebra portion of the back of the user pushing against the facing side of the rolling back massage stem 23 in sequence along each of the two lines of Jia-Ji acupoints joining the coccyx portion, the lumbar vertebra portion, the thoracic vertebra portion, and the seventh cervical vertebra portion of the back of the user.
(h) Gradually squat down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the each of the two lines of Jia-Ji acupoints joining the coccyx portion, the lumbar vertebra portion, the thoracic vertebra portion, and the seventh cervical vertebra portion of the back of the user.
(i) Repeat the step (g) and the step (h) for corresponding time periods in sequence.
(j) Start from the leg squatting position by the user while the coccyx portion along each of the four bladder meridian lines of the back of the user pushing against the facing side of the rolling back massage stem 23.
(k) Gradually rise up from the leg squatting position to the rising position by the user while the lumbar vertebra portion, the thoracic vertebra portion and the seventh cervical vertebra portion of the back of the user pushing against the facing side of the rolling back massage stem 23 in sequence along each of the four Bladder meridian lines joining the coccyx portion, the lumbar vertebra portion, the thoracic vertebra portion, and the seventh cervical vertebra portion of the back of the user.
(l) Gradually squat down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the each of the four Bladder meridian lines joining the coccyx portion, the lumbar vertebra portion, the thoracic vertebra portion, and the seventh cervical vertebra portion of the back of the user.
(m) Repeat the step (k) and the step (l) for corresponding time periods in sequence.

Alternatively, according to the preferred embodiment, a rolling back method for the far infrared rolling back healthcare massage device is provided, which comprises steps of:
(i) Arrange the elongated rolling back massage stem 23 securely and vertically supported by the support frame 10 on an exercise surface and switch on the far infrared ray generator 30 to emit a far infrared ray, which is provided along the rolling back massage stem 23, towards a treatment space (i.e. the space surrounding by the rolling back apparatus 20 and the support frame 10) of the far infrared rolling back healthcare massage device.
(ii) Simulate a Governor vessel line of a back of a user while the user starts from a leg squatting position within the treatment space while a coccyx portion along the Governor vessel line of the back of the user pushing against a facing side of the rolling back massage stem 23, gradually rises up from the leg squatting position to a rising position by the user while a lumbar vertebra portion, a thoracic vertebra portion and a seventh cervical vertebra portion of the back of the user pushing against the facing side of the rolling back massage stem 23 in sequence along the Governor vessel line joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the Governor vessel line joining the coccyx portion, the lumbar vertebra portion, the thoracic vertebra portion, and the seventh cervical vertebra portion of the back of the user.
(iii) Stimulate each of two lines of Jia-Ji acupoints of the back of the user while the user starts from the leg squatting position while the coccyx portion along each of the two lines of Jia-Ji acupoints of the back of the user pushing against the facing side of the rolling back massage stem 23, gradually rises up from the leg squatting position to the rising position by the user while the lumbar vertebra portion, the thoracic vertebra portion and the seventh cervical vertebra portion of the back of the user pushing against the facing side of the rolling back massage stem 23 in sequence along each of the two lines of Jia-Ji acupoints joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the each of the two lines of Jia-Ji acupoints joining the coccyx portion, the lumbar vertebra portion, the thoracic vertebra portion, and the seventh cervical vertebra portion of the back of the user.
(iv) Stimulate each of four bladder meridian lines of the user while the user starts from the leg squatting position by the user while the coccyx portion along each of the four bladder meridian lines of the back of the user pushing against the facing side of the rolling back massage stem 23, gradually rises up from the leg squatting position to the rising position by the user while the lumbar vertebra portion, the thoracic vertebra portion and the seventh cervical vertebra portion of the back of the user pushing against the facing side of the rolling back massage stem 23 in sequence along each of the four Bladder meridian lines joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem 23 in sequence along the each of the four Bladder meridian lines joining the coccyx portion, the lumbar vertebra portion, the thoracic vertebra portion, and the seventh cervical vertebra portion of the back of the user.

It is appreciated that in the Governor vessel line, the action of the rolling back massage is that the body's back moves up along a line joining four points, and moves down along a line joining four points. The movement of the rolling up and the rolling down is one cycle. The same movement is for the other six lines that the body's back moves along a line joining the acupoints.

During the spinal exercise with the rolling back method of the present invention, the massaging elements 242A, 242B, 242C are oriented for touching, rubbing and/or kneading on the user's back. The far infrared ray generator 30 is built-in the rolling back apparatus 20 in such a manner that the far infrared ray generator 30 can be provided between a center rod of the rolling back massage stem 23 and the massaging arrangement 24.

Accordingly, the human spinal flexing motion and the effects of “weight-bearing” of the spine in the health campaigns. Through the flexing and extending movement of the user, the legs and trunk are together within the action that the legs movements drive the upper body of the user to roll the body's back to achieve healthcare massage and the stimulating effects of acupoints and meridians on the body's back. At the same time, the crowded force of the rolling back massage stem 23 on the spinal bone produces the effects of weight-bearing on the spine, which increases the density of the spinal bone.

According to the preferred embodiment, at least one vertical column of the first, second or third massaging elements 242A, 242B, 242C of the massaging arrangement 24 of the rolling back massage stem 23 is provided that the user is able to select one vertical row of the first, second or third massaging elements 242A, 242B, 242C to be oriented for back massage and acupuncture and moxibustion with non-invasive and painless therapy.

In addition, by means of the pivot stem base 230, the rolling back massage stem 23 can be rotated to orient the corresponding vertical column of the first, second or third massaging elements 242A, 242B, 242C for touching, rubbing and/or kneading on the user's back. In other words, the rolling back massage stem 23 selectively orients one or more corresponding vertical columns of the first, second or third massaging elements 242A, 242B, 242C for back massaging and acupuncture and moxibustion with non-invasive and painless therapy.

The distance adjustment between the left handle 11 and the right handle 12 with respect to the rolling back massage stem 23 ensures the proper hand grip positions of the user during the flexing and extending movement. In addition, as shown in FIG. 2 and FIG. 11, the roller wheels 15, 16 may also be provided with a ground stopper 151, 161 for detachably biasing against the ground surface to retain the left and right handles 11, 12 in position.

It is worth mentioning that, in order to more stably and rigidly set up the far infrared rolling back healthcare massage device of the present invention, the upper supporter 21 and the lower supporter 22 can also be affixed to the wall surface. The user may select to grip on the left and right handles 11, 12 or without gripping on the left and right handles 11, 12 while performing the flexing and extending movement by leg squatting and rising exercise, which is executing the above step (a) to step (o) of the rolling back method.

The assembling and preparing of the far infrared rolling back healthcare massage device for the rolling back method performed by the user, the following steps are included:
(1) Support the rolling back apparatus 20 by the support frame 10.
(2) Arrange and adjust the left handle 11 and right handle 12 to desired positions for guiding the user to perform the flexing and extending movement by gripping the left handle 11 and the right handle 12 with the left hand and the right hand of the user respectively.
(3) Extend the rolling back massage stem 23 between the upper supporter 21 and the lower supporter 22 at a predetermined position. Preferably, the user is able to select one or more of the vertical columns of the first, second or third massaging elements 242A, 242B, 242C for back massage and acupuncture and moxibustion with non-invasive and painless therapy on the user's back during the flexing and extending movement.
(4) When performing acupuncture and moxibustion with non-invasive and painless special acupoint therapy, the user should adjust the speed of the movements and the intensity of the pressure on the back rolling rod according to the feeling of the acupoints and meridians on the body's back, and also adjust the intensity of far-infrared radiation.
(5) When performing acupuncture and moxibustion with non-invasive and painless acupoint therapy, it is better if the user feels mild heat and deep penetration, and the body feels an increase in body temperature and slight sweating. The user should slow down or take a break at this time and replenish water appropriately. Do not raise body temperature rapidly or sweat profusely.

In view of above, the present invention achieves the advantages of “Fitness+Healthcare”, and also has a simple structure, convenient and effective, self-help healthcare massage and acupuncture and moxibustion with non-invasive and painless specific acupoint therapy, and other advantages:
(1) The present invention provides an innovative device of healthcare massage and acupuncture and moxibustion with non-invasive and painless specific acupoint therapy:

The using the far infrared rolling back healthcare massage device requires the movements of human legs and torso in order to achieve the effect of the body back massage and acupuncture and moxibustion with non-invasive and painless special acupoint therapy. This is a new self-help equipment that physical exercise combined with body back massage and acupuncture and moxibustion with non-invasive and painless specific acupoint therapy.
(2) Enhancing spinal health and spine anti-aging: Prof, Dr. Juergen Kraemer said: “Spinal degenerative changes and intervertebral disk diseases are as old as humanity itself.” “Histological studies regularly show degenerative changes in all structural components of the intervertebral disk beginning in the third decade of life, with cell degeneration, cell loss, fiber degeneration, and loosening of the matrix.” “A regular alternation of mechanical stress and relaxation aids intradiscal metabolism, but a constantly maintained posture-particularly one in which the spine is under stress-impairs it.”

Utilizing the far infrared rolling back healthcare massage device of the present invention, the forward bent of the body and the back extension can change the overall mechanical pressure of the lumbar intervertebral, disc, and improve disc nutrition. This will slow down and improve the human necessity of early degenerative changes of the intervertebral disc.
(3) While massaging the spine, far infrared ray acupuncture and moxibustion with non-invasive and painless specific acupoint therapy on the Governor vessel to dredge Governor vessel and promote blood circulation of the central nervous system, and to assist the spine with obtaining nutrients, that can prevent ossification of spinal ligament, muscle atrophy, joint stiffness and osteoporosis, and regulate and improve the function of the central nervous system.
(4) Preventing and improving displacement of spinal bone. During the rolling back massaging reverse back scrolls along the Jia-Ji acupoints, it can adjust the tension of spine ligaments and muscles on both sides, correct the spinal side displaced state, and prevent and improve the spinal dislocation.
(5) While massaging the Jia-Ji acupoints, the far infrared ray acupuncture and moxibustion with non-invasive and painless therapy on Jia-Ji acupoints, the stimulating of the Jia-Ji acupoints can promote the reflex function of the central nervous system to activate the cells of the spinal cord and brain.
(6) While rolling back massaging along the Back-Shu acupoints of Bladder meridian, it is to regulate and promote the physiological function of viscera and organs of the body holistically.
(7) While massaging the Back-Shu acupoints of Bladder meridian, the far infrared ray acupuncture and moxibustion with non-invasive and painless specific acupoint therapy on the Back-Shu acupoints, it is to communicate the Governor vessel and the bladder meridian to links kidney function, spinal cord and brain, and promotes the regenerative function of spinal cord and brain cells.
(8) Self-help massage: The far infrared rolling back healthcare massage device of the present invention does not need others to help or to perform the massage, but only needs to rely on their own leg strength and flexing and extending movements of the upper body. It is achieved by their own back massage and acupuncture and moxibustion with non-invasive and painless specific acupoint therapy.
(9) Controllable and security: During the rolling back healthcare massage, the user may control the pressure on the rolling back massage stem 23 and the massaging arrangement 24 and the predetermine period of exercise time for each exercise and massage by himself or herself. The left handle 11 and the right handle 12 can be used by the user to facilitate hand-held to prevent falls. In addition, the safety belts 41, 42 on both sides of the user's body can protect the user from falling down too.
(10) During the rolling back healthcare massage with the far infrared ray acupuncture and moxibustion with non-invasive and painless specific acupoint therapy, the intensity and time of the action can be adjusted by the user, and the high, medium and low levels of far infrared radiation can be regulated by user according to the body feel of the user.
(11) Simple and easy to use: The arrangement of the far infrared rolling back healthcare massage device simply comprises the rolling back apparatus 20 and the support frame 10 that are easy to assemble and set up without special requirements for the space.
(12) Economic and benefits: The universal arrangement of the far infrared rolling back healthcare massage device has a low manufacturing cost and is adapted to be used at home or working environment of the user anytime without post-maintenance cost. Family members, especially the elders, are free to arrange time to have the rolling back healthcare massage.
(13) The adaptation to a wide range: Due to human birth defects of the spine, the spine degenerative changes in the beginning about the age of 20. Therefore, the far infrared rolling back healthcare massage device of the present invention is especially good for young people age of 20 and over. During the rolling back massage, the degree of leg flexing and extending and upper body portion can be adjusted according to their physical condition.
(14) Definite healthcare effects: The present invention focuses on the human back massage of three important meridians and acupoints. Using the body's own leg strength along the points of the back and the action of body flexing and extending to achieve the purpose of back massage, acupuncture and moxibustion with non-invasive and painless special acupoint therapy. This is an innovative concept and an exercise mode of “Fitness+Healthcare” and practices. It is to enhance physical fitness, prevent diseases, improve spinal age-related diseases associated with aging and has a positive meaning.
(15) Easy to understand: Referring to FIG. 15 to FIG. 17, the line along the central spine is the Governor vessel. Along the middle line of the spine and blades edge, then along the edge line of the blades is the bladder meridian. The meridian and acupoints of the back locate the center and both sides of symmetry. The Jia-Ji acupoints are located on both sides of the spinal process. Easy to learn and master.

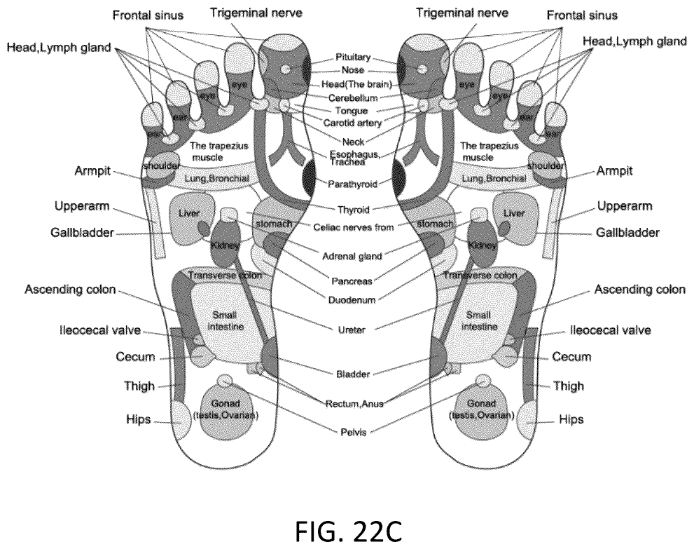

Referring to FIG. 22A to FIG. 22C, the far infrared rolling back healthcare massage device may further comprise a foot massage mat 60 configured to be placed on ground for the user to position his or her left and right feet thereon while conducting exercise with the far infrared rolling back healthcare massage device as shown in FIG. 22A. The Yong-Quan acupoint on the soles of human feet is big point of foot center show in FIG. 22A. The kidney meridian starts from YongQuan acupoint. While rolling the back to massage the Governor vessel and Bladder meridia, it stimulates and massages Yong-Quan acupoint, which is conducive to the communication between the kidney meridian and the Governor vessel and the Bladder meridian. Referring to FIG. 18, various types of foot massage mat can be used. According to the preferred embodiment, as shown in FIG. 22A, the foot massage mat 60 comprises two foot portions 61, 62 spaced and sized adapted for the left foot and right foot of the user with a designated shoe size thereof to step thereon respectively, wherein a plurality of acupressure protrusions 600 is protruded on two foot portions 61, 62 of the foot massage mat 60, which are distributed according to the acupoints of the soles of the left and right feet of the user according to the acupoints as shown in FIG. 22C, for example. FIG. 22B illustrates example of the configuration of the acupressure protrusions 600, wherein it should be noted that other acupressure protrusions can be configured, such as rotatable acupressure balls, and far infrared ray generator can also be equipped in the foot massage mat 60.

According to the above description, the far infrared rolling back healthcare massage device of the present invention puts humans in an active position in life activities, actively prevents the occurrence of diseases, and becomes the master of their own health. Far infrared ray is applied to the user's back in an innovative way that can replace the acupuncture and moxibustion of the traditional Chinese medical with non-invasive and painless therapy while combining with the rolling back healthcare massage. In other words, non-invasive and painless acupuncture and moxibustion are combined by means of the far infrared rays applied in specific and innovative way that have both effects of deep penetration function and thermal function of acupuncture and moxibustion of the traditional Chinese medical therapy.

It is appreciated that the far infrared rolling back healthcare massage device of the present invention form a trinity structure system of rolling back of the user, including (1) exercise, (2) back healthcare massage and (3) acupuncture and moxibustion therapy, wherein by means of the trinity structure of far infrared rolling back health massage device of the present invention, back healthcare massage and acupuncture and moxibustion to be realized through legs squat and rising body movement, such that back health massage maintains and enhances the normal physiological functions of the spine, while enabling acupuncture and moxibustion to achieve better efficacy. In other words, the present invention allows the user to achieve fitness and healthcare at the same time.

It is well known that molecular biology reveals that the genetic sequence of an organism determines its structure, and the structure determines its function. Cells are the basic unit of lift and protein is the main component of cells. The amino acid sequence of a protein determines its three-dimensional structure and can produce stable functionality. The trinity structure of the far infrared rolling back healthcare massage device according to the present invention conforms to the basic laws of biological structure and function. It can be interpreted that the trinity structure is the hardware of body exercise, back healthcare massage and acupuncture and moxibustion therapy, and the rolling back massage of Governor vessel, Jia-Ji acupoints and Bladder meridian by the rolling back massage through the far infrared rolling back healthcare massage device with acupuncture and moxibustion therapy is the software of body exercise. The hardware functions of exercise, back healthcare massage and acupuncture and moxibustion therapy are to promote blood circulation in the human body that belongs to the matter form of human life activities. The software functions of rolling back massage on Governor vessel, Jia-Ji acupoints and Bladder meridian promote dredge meridians circulation, that belong to energy form of human life activities. The combined functions of such hardware and software in the present invention achieve the dynamic balance of the matter form and energy form of human life activities.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and are subject to change without departure from such principles. Therefore, this invention includes all modifications encompassed within the spirit and scope of the following claims.

What is claimed is:

1. A far infrared rolling back healthcare massage device for a user to perform a flexing and extending movement by leg squatting and rising and to back-massage, acupuncture and moxibustion with noninvasive and painless therapy by self-help at the same time, comprising:
a support frame; and
a rolling back apparatus, supported by said support frame, comprising:
an upper supporter and a lower supporter spacedly mounted by said support frame to have an exercise distance therebetween;
an elongated rolling back massage stem securely and vertically supported between said upper supporter and said lower supporter along said exercise distance;
a massaging arrangement comprising an elongated hollow body provided along at least one portion of said rolling back massage stem coaxially and a plurality of massaging elements spacedly provided on said body and oriented for selectively touching, rubbing and kneading against a back of the user when the user is performing the flexing and extending movement by leg squatting and rising with the back of the user touching and pushing rearwards against said massaging arrangement; and
a far infrared ray generator which is arranged in said rolling back massage stem and extended along said massaging arrangement and configured to generate a far infrared ray radiating towards a treatment space defined by said rolling back massage stem and said support frame while the user is exercising with said rolling back massage stem;
thereby while performing the flexing and extending movement by the user, the back of the user is pushed against said massaging arrangement so as to self-apply a massaging pressure on a portion of the back of the user where pushing against said rolling back massage stem for back massaging while said far infrared ray generator radiating the far infrared ray in the treatment space.

2. The far infrared rolling back healthcare massage device, as recited in claim 1, wherein one or more of the massaging elements of the massaging arrangement is provided with at least one far-infrared ray channel communicating said far infrared ray generator with outside, such that the far infrared ray radiated from the far infrared ray generator penetrates through said far-infrared ray channel and applies to the back of the user pressing against the one or more massaging elements with said at least one far-infrared ray channel.

3. The far infrared rolling back healthcare massage device, as recited in claim 2, wherein said upper supporter comprises a pair of first support member and second support member, each of which has a pivot joint, wherein said pivot joints of said first support member and said second support member are pivotally connected together in such a manner that said first support member and said second support member are able to be rotated with respect to each other about said pivot joints thereof, wherein said lower supporter comprises a pair of first support arm and second support arms, each of which has a pivoting joint, wherein said pivoting joints of said first support arm and said second support arm are pivotally connected together in such a manner that said first support arm and said second support arm are able to be rotated with respect to each other about said pivoting joints thereof.

4. The far infrared rolling back healthcare massage device, as recited in claim 3, further comprising a first mounting post and a second mounting post, wherein said first mounting post is fixedly mounted between said first support member and said first support arm said second mounting post is fixedly mounted between said second support member and said second support arm.

5. The far infrared rolling back healthcare massage device, as recited in claim 4, wherein said support frame comprises a left handle and a right handle respectively provided at a left side and a right side thereof, thereby said left handle and said right handle are configured to allow both hands of the user to hold on respectively while performing the flexing and extending movement and allow the user to push the left handle and right handle to generate a reaction force rearwards to push the back of the user against said massaging arrangement so as to self-apply a massaging pressure on a portion of the back of the user where pushing against said rolling back massage stem for back massaging while said far infrared ray generator radiating far infrared ray in the treatment space.

6. The far infrared rolling back healthcare massage device, as recited in claim 5, wherein said support frame further comprises a pair of first upper supporting arm and first lower supporting arm and a pair of second upper supporting arm and second lower supporting arm, wherein said first supporting arm and said first lower supporting arm are pivotally coupled with said upper supporter and said lower supporter respectively, wherein said second supporting arm and said second lower supporting arm are pivotally coupled with said upper supporter and said lower supporter respectively, wherein said left handle is an elongated bar extended between said first upper supporting arm and said first lower supporting arm, and said right handle is an elongated bar extended between said second upper supporting arm and said second lower supporting arm.

7. The far infrared rolling back healthcare massage device, as recited in claim 6, wherein each of said first upper supporting arm, said first lower supporting arm, said second upper supporting arm, and said second lower supporting arm is extensible to adjust a distance between each of said left handle and said right handle with respect to said rolling back massage stem.

8. The far infrared rolling back healthcare massage device, as recited in claim 7, wherein each of said first upper supporting arm, said first lower supporting arm, said second upper supporting arm, and said second lower supporting arm is extensible to adjust a distance between each of said left handle and said right handle with respect to said rolling back massage stem.

9. The far infrared rolling back healthcare massage device, as recited claim 8, wherein each of said first upper supporting arm and said first lower supporting arm comprises a tubular first support bracket and a first extending arm having one end inserted into said first support bracket and another end extended out of said first support bracket to connect with one end of said left handle, wherein each of said second upper supporting arm and said second lower supporting arm comprises a tubular second support bracket and a second extending arm having one end inserted into said second support bracket and another end extended out of said second support bracket to connect with one end of said right handle.

10. The far infrared rolling back healthcare massage device, as recited in claim 1, wherein said massaging elements are arranged in one or more longitudinal columns protruded along said body of said massaging arrangement.

11. The far infrared rolling back healthcare massage device, as recited in claim 2, wherein said massaging elements are arranged in one or more longitudinal columns protruded along said body of said massaging arrangement.

12. The far infrared rolling back healthcare massage device, as recited in claim 10, wherein said massaging arrangement is extended along at least a central portion for a predetermined length of said rolling back massage stem and has a first longitudinal portion, a second longitudinal portion a third longitudinal portion, each having an included angle of 120 degrees, wherein said longitudinal portion of said massaging arrangement has a plurality of first massaging elements of said massaging elements protruded spacedly and longitudinal thereon, wherein said second longitudinal portion of said massaging arrangement has a plurality of second massaging elements of said massaging elements protruded spacedly and longitudinal thereon, wherein said third longitudinal portion of said massaging arrangement has a plurality of third massaging elements of said massaging elements protruded spacedly and longitudinal thereon, wherein said massaging arrangement is rotatable to adjust one of said first longitudinal portion, said second longitudinal portion and said third longitudinal portion facing frontwards.

13. The far infrared rolling back healthcare massage device, as recited in claim 12, said plurality of said first massaging elements is arranged in linear manner to form one column of first massaging elements spacedly, which is adapted to stimulate a Governor vessel of the user when the user is performing the flexing and extending movement by leg squatting and rising with the Governor vessel of the back of the user touching and pushing rearwards against said first massaging elements of said massaging arrangement, wherein each of said plurality of second massaging elements is a tubular body in conical shape defining at least one axial through hole as a second far-infrared ray channel for communicating said far infrared ray generator with outside, wherein at least one column of said second massaging elements are protruding heads integrally and radically protruded along said body of said massaging arrangement in a spaced manner, wherein said at least one column of said second massaging elements are arranged to provide stimulating effect to the back of the user when a pressure is applied thereagainst by the back of the user to stimulate the acupoints of Jia-Ji acupoints in the back of the user when the user is performing the flexing and extending movement by leg squatting and rising with Jia-Ji acupoints and bladder meridian on the back of the user touching and pushing rearwards against said second massaging elements of said massaging arrangement, wherein said far-infrared ray generated by said far infrared red ray generator penetrates through said second far-infrared ray channel to apply on the Jia-Ji acupoints to the back of the user pressing against said corresponding second massaging elements, wherein each of said plurality of third massaging elements is a tubular body in semi-ellipsoid shape defining at least one through hole as a third far-infrared ray channel for communicating said far infrared ray generator with outside, wherein one column of said plurality of said third massaging elements are protruded heads integrally and linearly protruded along said body of said massaging arrangement in a spaced manner, wherein said column of said third massaging elements is adapted to stimulate the Bladder meridian of the user when the user is performing the flexing and extending movement by leg squatting and rising with the Bladder meridian of the back of the user touching and pushing rearwards against said third massaging elements of said massaging arrangement, wherein said far-infrared ray generated by said far infrared red ray generator penetrates through said third far-infrared ray channel to apply on the acupoints along the Bladder meridian of the back of the user pressing against said corresponding third massaging elements.

14. The far infrared rolling back healthcare massage device, as recited in claim 11, wherein said massaging arrangement is extended along at least a central portion for a predetermined length of said rolling back massage stem and has a first longitudinal portion, a second longitudinal portion a third longitudinal portion, each having an included angle of 120 degrees, wherein said longitudinal portion of said massaging arrangement has a plurality of first massaging elements of said massaging elements protruded spacedly and longitudinal thereon, wherein said second longitudinal portion of said massaging arrangement has a plurality of second massaging elements of said massaging elements protruded spacedly and longitudinal thereon, wherein said third longitudinal portion of said massaging arrangement has a plurality of third massaging elements of said massaging elements protruded spacedly and longitudinal thereon, wherein said massaging arrangement is rotatable to adjust one of said first longitudinal portion, said second longitudinal portion and said third longitudinal portion facing frontwards.

15. The far infrared rolling back healthcare massage device, as recited in claim 14, said plurality of said first massaging elements is arranged in linear manner to form one column of first massaging elements spacedly, which is adapted to stimulate a Governor vessel of the user when the user is performing the flexing and extending movement by leg squatting and rising with the Governor vessel of the back of the user touching and pushing rearwards against said first massaging elements of said massaging arrangement, wherein each of said plurality of second massaging elements is a tubular body in conical shape defining at least one axial through hole as a second far-infrared ray channel for communicating said far infrared ray generator with outside, wherein at least one column of said second massaging elements are protruding heads integrally and radically protruded along said body of said massaging arrangement in a spaced manner, wherein said at least one column of said second massaging elements are arranged to provide stimulating effect to the back of the user when a pressure is applied thereagainst by the back of the user to stimulate the acupoints of Jia-Ji acupoints in the back of the user when the user is performing the flexing and extending movement by leg squatting and rising with Jia-Ji acupoints on the back of the user touching and pushing rearwards against said second massaging elements of said massaging arrangement, wherein said far-infrared ray generated by said far infrared red ray generator penetrates through said second far-infrared ray channel to apply on the Jia-Ji acupoints to the back of the user pressing against said corresponding second massaging elements, wherein each of said plurality of third massaging elements is a tubular body in semi-ellipsoid shape defining at least one through hole as a third far-infrared ray channel for communicating said far infrared ray generator with outside, wherein one column of said plurality of said third massaging elements are protruded heads integrally and linearly protruded along said body of said massaging arrangement in a spaced manner, wherein said column of said third massaging elements is adapted to stimulate the Bladder meridian of the user when the user is performing the flexing and extending movement by leg squatting and rising with the Bladder meridian of the back of the user touching and pushing rearwards against said third massaging elements of said massaging arrangement, wherein said far-infrared ray generated by said far infrared red ray generator penetrates through said third far-infrared ray channel to apply on the acupoints along the Bladder meridian of the back of the user pressing against said corresponding third massaging elements, wherein at least a row of said one or more vertical rows of said massaging elements are pillars, each having a circular cross section.

16. The far infrared rolling back healthcare massage device, as recited in claim 10, wherein at least a column of said one or more longitudinal columns of said massaging elements are protruding conical shape elements.

17. The far infrared rolling back healthcare massage device, as recited in claim 10, wherein at least a column of said one or more longitudinal columns of said massaging elements are protruding semi-ellipsoid shape elements.

18. The far infrared rolling back healthcare massage device, as recited in claim 1, wherein said rolling back massaging arrangement is a massaging sleeve detachably coupled along said rolling back massage stem, wherein a rolling back massaging portion is formed on an outer circumferential surface of said massaging sleeve to match said rolling back massage stem, wherein said massaging sleeve has two detachable edges to allow said massaging sleeve to be selectively detached and re-coupled from an outer surface of said rolling back massage stem.

19. The far infrared rolling back healthcare massage device, as recited in claim 1, wherein said far infrared ray generator is a far infrared ray generating member arranged between said rolling back massage stem and said massaging arrangement.

20. The far infrared rolling back healthcare massage device, as recited in claim 15, wherein said far infrared ray generator is a far infrared ray generating member arranged between said rolling back massage stem and said massaging arrangement.

21. The far infrared rolling back healthcare massage device, as recited in claim 1, wherein said far infrared rolling back healthcare massage device is configured to execute a rolling back method of a trinity structure to run through a hardware and software of said far infrared rolling back healthcare massage device, wherein an implement of said rolling back method realizes a new concept of Fitness plus Healthcare.

22. A rolling back method of a far infrared rolling back healthcare massage device, comprising:
(a) providing an elongated rolling back massage stem securely and vertically supported by a support frame on an exercise surface and emitting a far infrared ray from a far infrared ray generator, which is provided along said rolling back massage stem, towards a treatment space of said far infrared rolling back healthcare massage device;
(b) starting from a leg squatting position by a user within the treatment space while a coccyx portion along a Governor vessel line of a back of the user pushing against a facing side of said rolling back massage stem;
(c) gradually rising up from the leg squatting position to a rising position by the user while a lumbar vertebra portion, a thoracic vertebra portion and a seventh cervical vertebra portion of the back of the user pushing against a facing side of said rolling back massage stem in sequence along the Governor vessel line joining the coccyx portion, the lumbar vertebra portion, the thoracic vertebra portion, and the seventh cervical vertebra portion of the back of the user;
(d) gradually squatting down from the rising position to the leg squatting position by the user while the seventh cervical vertebra portion, the thoracic vertebra portion, the lumbar vertebra portion, and the coccyx portion of the back of the user pushing against said facing side of said rolling back massage stem in sequence along the Governor vessel line joining the coccyx portion, the lumbar vertebra portion, the thoracic vertebra portion, and the seventh cervical vertebra portion of the back of the user;
(e) repeating the step (c) and the step (d) for corresponding time periods in sequence;
(f) starting from the leg squatting position by the user while the coccyx portion along each of the two lines of Jia-Ji acupoints of the back of the user pushing against said facing side of said rolling back massage stem;
(g) gradually rising up from the leg squatting position to the rising position by the user while the lumbar vertebra portion, the thoracic vertebra portion and the seventh cervical vertebra portion of the back of the user pushing against said facing side of said rolling back massage stem in sequence along each of the two lines of Jia-Ji acupoints joining the coccyx portion, the lumbar vertebra portion, the thoracic vertebra portion, and the seventh cervical vertebra portion of the back of the user;
(h) gradually squatting down from the rising position to the leg squatting position by the user while the seventh cervical vertebra portion, the thoracic vertebra portion, the lumbar vertebra portion, and the coccyx portion of the back of the user pushing against said facing side of said rolling back massage stem in sequence along each of the two lines of Jia-Ji acupoints joining the coccyx portion, the lumbar vertebra portion, the thoracic vertebra portion, and the seventh cervical vertebra portion of the back of the user;
(i) repeating the step (g) and the step (h) for corresponding time periods in sequence;
(j) starting from the leg squatting position by the user while the coccyx portion along each of the four bladder meridian lines of Jia-Ji acupoints of the back of the user pushing against said facing side of said rolling back massage stem;
(k) gradually rising up from the leg squatting position to a rising position by the user while the lumbar vertebra portion, the thoracic vertebra portion and the seventh cervical vertebra portion of the back of the user pushing against said facing side of said rolling back massage stem in sequence along each of the four bladder meridian lines joining the coccyx portion, the lumbar vertebra portion, the thoracic vertebra portion, and the seventh cervical vertebra portion of the back of the user;
(l) gradually squatting down from the rising position to the leg squatting position by the user while the seventh cervical vertebra portion, the thoracic vertebra portion, the lumbar vertebra portion, and the coccyx portion of the back of the user pushing against said facing side of said rolling back massage stem in sequence along the each of the four bladder meridian lines joining the coccyx portion, the lumbar vertebra portion, the thoracic vertebra portion, and the seventh cervical vertebra portion of the back of the user; and
(m) repeating the step (k) and the step (l) for corresponding time periods in sequence.

23. A rolling back method for the far infrared rolling back healthcare massage device, comprising steps of:
(i) arranging an elongated rolling back massage stem securely and vertically supported by a support frame on an exercise surface of the far infrared rolling back healthcare massage device and switching on a far infrared ray generator to emit a far infrared ray, which is provided along the rolling back massage stem, towards a treatment space of the far infrared rolling back healthcare massage device;
(ii) simulating a Governor vessel line of a back of a user while the user starts from a leg squatting position within the treatment space while a coccyx portion along the Governor vessel line of the back of the user pushing against a facing side of the rolling back massage stem, gradually rises up from the leg squatting position to a rising position by the user while a lumbar vertebra portion, a thoracic vertebra portion and a seventh cervical vertebra portion of the back of the user pushing against the facing side of the rolling back massage stem in sequence along the Governor vessel line joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the Governor vessel line joining the coccyx portion, the lumbar vertebra portion, the thoracic vertebra portion, and the seventh cervical vertebra portion of the back of the user;
(iii) stimulating each of two lines of Jia-Ji acupoints of the back of the user while the user starts from the leg squatting position while the coccyx portion along each of the two lines of Jia-Ji acupoints of the back of the user pushing against the facing side of the rolling back massage stem, gradually rises up from the leg squatting position to the rising position by the user while the lumbar vertebra portion, the thoracic vertebra portion and the seventh cervical vertebra portion of the back of the user pushing against the facing side of the rolling back massage stem in sequence along each of the two lines of Jia-Ji acupoints joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the each of the two lines of Jia-Ji acupoints joining the coccyx portion, the lumbar vertebra portion, the thoracic vertebra portion, and the seventh cervical vertebra portion of the back of the user; and
(iv) stimulating each of four bladder meridian lines of the user while the user starts from the leg squatting position by the user while the coccyx portion along each of the four bladder meridian lines of the back of the user pushing against the facing side of the rolling back massage stem, gradually rises up from the leg squatting position to the rising position by the user while the lumbar vertebra portion, the thoracic vertebra portion and the seventh cervical vertebra portion of the back of the user pushing against the facing side of the rolling back massage stem in sequence along each of the four Bladder meridian lines joining the coccyx portion, the lumbar vertebra portion, the thoracic vertebra portion, and the seventh cervical vertebra portion of the back of the user, and gradually squats down from the rising position to the leg squatting position by the user while the seventh cervical vertebra portion, the thoracic vertebra portion, the lumbar vertebra portion, and the coccyx portion of the back of the user pushing against the facing side of the rolling back massage stem in sequence along the each of the four Bladder meridian lines joining the coccyx portion, the lumbar vertebra portion, the thoracic vertebra portion, and the seventh cervical vertebra portion of the back of the user.
